(19) United States
(12) Patent Application Publication
(10) Pub. No.: US 2012/0106364 A1
(43) Pub. Date: May 3, 2012

(54) HETEROGENEOUS COEXISTENCE MANAGEMENT IN SECONDARY NETWORKS

(75) Inventors: Mika KASSLIN, Espoo (FI); Juha Salokannel, Tampere (FI); Jari Junell, Espoo (FI); Päivi Ruuska, Tampere (FI)

(73) Assignee: Nokia Corporation, Espoo (FI)

(21) Appl. No.: 12/915,154

(22) Filed: Oct. 29, 2010

(51) Int. Cl. H04L 12/26

(52) U.S. Cl. 370/252

(57) ABSTRACT

Method, apparatus, and computer program product embodiments are disclosed to provide for wireless resource sharing between heterogeneous wireless networks to enable coexistence in a TV band white space. An example embodiment of the invention includes a method, comprising the steps of: registering coexistence information services to a wireless network, wherein decisions concerning operational parameters of the wireless network are made by a wireless device belonging to the wireless network; determining that the wireless network has one or more neighboring wireless networks; receiving a satisfaction level indication for the wireless network, the satisfaction level indication representing how satisfied the wireless network is with current communication resources; and notifying one or more network controllers serving the one or more neighboring wireless networks of the registered service type and the satisfaction level indication of the wireless network.

### FIELD

The field of the invention relates to radio coexistence concepts and utilization of RF spectrum to provide for wireless resource sharing between heterogeneous wireless networks to enable coexistence of secondary networks.

### BACKGROUND

Use of radio frequency bands of the electromagnetic spectrum is regulated by governments in most countries, by allocating specific frequency bands to particular types of uses, such as licensed bands for commercial radio and television broadcasting, cellular telephony, maritime radio, police, fire, and public safety radio, GPS, radio astronomy, earth stations for satellite communications, and many other uses. Governments also allocate unlicensed bands, for example, for Wireless Regional Area Network (WRAN) broadband access for rural areas and wireless local area networks (WLAN) and wireless personal area networks (WPAN), such as the industrial, scientific, and medical (ISM) band.

In the United States, the Federal Communications Commission (FCC) regulates use of the radio spectrum, including radio and television broadcasting. Frequencies are allocated according to a bandplan in which guard bands are assigned between the allocated radio bands to avoid interference between adjacent signals. There are also unassigned frequency bands in the spectrum that either have never been used or have become free as a result of changes in technology. The unassigned frequency bands and guard bands are referred to as white spaces.

TV white space may be broadly defined as broadcast television spectrum that is unused by licensed services. There are at least two categories of TV white space: [1] Dedicated TV white space is a portion of the spectrum that the FCC has reallocated to unlicensed use from previously analog broadcast usage, and [2] Locally unused spectrum by licensed TV broadcasters in a geographic area.

[1] Dedicated TV white space: In the United States, the FCC has dedicated approximately 400 MHz of white spaces for unlicensed use that became unused after a federally mandated transformation of analog TV broadcasting to digital TV broadcasting. However, the FCC has prohibited unlicensed use of white spaces from interfering with existing licensed uses, including digital TV stations, low power TV stations, cable TV headends, and sites where low power wireless microphones are used. Various proposals have been made for unlicensed use of the white spaces left by the termination of analog TV, for example rural broadband deployment, auxiliary public safety communications, educational and enterprise video conferencing, personal consumer applications, mesh networks, security applications, municipal broadband access, enhanced local coverage and communications, fixed backhaul, and sensor aggregation for smart grid meter reading.

[2] Locally unused spectrum by licensed TV broadcasters: The FCC has adopted rules to allow unlicensed radio transmitters to operate in the broadcast television spectrum at locations where that spectrum is not being used by licensed broadcasters. The FCC required the use of geolocation to establish the location of the unlicensed transmitter and a database of TV bands use by licensed broadcasters organized by their geographic coverage areas, to enable the unlicensed transmitter to know where local TV band white spaces may be available. The FCC required the use of spectrum sensors in the unlicensed transmitter to detect the presence of the incumbent, primary TV broadcaster's signal in the local TV band white space to enable the unlicensed transmitter to immediately relinquish using the band. A primary user in such a local TV band white space would be an incumbent TV broadcaster licensed to operate in that band, but in those geographic areas where there are no licensed incumbent TV broadcasters in operation, other unlicensed secondary users may make use of that band.

Other RF spectrum white spaces may be locally unused in certain geographic areas, such as the frequency allocations from maritime radio in landlocked areas remote from the sea. A primary user in such a maritime radio band would be a maritime radio licensed to operate in that band, but in those geographic areas where there are no licensed maritime radios in operation, other unlicensed secondary users may make use of that band. Similarly, locally unused RF spectrum white spaces may be present in certain geographic locations, such as the frequency allocations from 2.025 GHz to 2.110 GHz for earth stations to transmit to communications satellites, in areas remote from such earth stations. A primary user in such a satellite earth station radio band would be a satellite earth station licensed to operate in that band, but in those geographic areas where there are no satellite earth stations in operation, other unlicensed secondary users may make use of that band.

### SUMMARY

Method, apparatus, and computer program product embodiments are disclosed for wireless resource sharing between heterogeneous wireless networks to enable coexistence of secondary networks.

An example embodiment of the invention includes a method, comprising the steps of:

registering coexistence information services to a wireless network, wherein decisions concerning operational parameters of the wireless network are made by a wireless device belonging to the wireless network;

determining that the wireless network has one or more neighboring wireless networks;

receiving a satisfaction level indication for the wireless network, the satisfaction level indication representing how satisfied the wireless network is with current communication resources; and

notifying one or more network controllers serving the one or more neighboring wireless networks of the registered service type and the satisfaction level indication of the wireless network.

An example embodiment of the invention includes a method, comprising the steps of:

receiving one or more reports from the one or more network controllers, including an indication of a type of coexistence system service of the one or more neighboring wireless networks as being the coexistence information services or a coexistence management service wherein one or more network controllers make decisions concerning operational parameters of the wireless network;

receiving a request from the control node associated with the wireless network, inquiring what portion of neighboring networks use a type of coexistence system service; and

providing information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

An example embodiment of the invention includes a method, comprising the steps of:

receiving operational parameters of the wireless network comprising bandwidth, utilization, maximum operation power, and antenna configuration; and

notifying one or more network controllers serving the one or more neighboring wireless networks of the operational parameters of the wireless network.

An example embodiment of the invention includes a method, comprising the steps of:

registering coexistence management services to a wireless network, wherein decisions concerning operational parameters of the wireless network are made by cooperative resource allocation between network controllers serving one or more neighboring wireless networks;

determining that the wireless network has one or more neighboring wireless networks;

determining that one or more of the neighboring wireless networks is registered to coexistence information services;

receiving a satisfaction level indication of the one or more neighboring wireless networks registered to coexistence information services, the satisfaction level indication representing how satisfied the one or more neighboring wireless networks registered to coexistence information services is with current communication resources; and

accounting for the satisfaction level indication of the one or more neighboring wireless networks in resource allocations to the wireless network registered to coexistence management services.

An example embodiment of the invention includes a method, comprising the steps of:

receiving one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service; and

reducing a probability of including a neighboring wireless network in reallocation of resources if the satisfaction level indication of the neighboring wireless network indicates that the neighboring wireless network is satisfied and the service type is the coexistence information services.

An example embodiment of the invention includes a method, comprising the steps of:

receiving one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service;

receiving a request from the control node associated with the wireless network, inquiring what portion of neighboring networks use a type of coexistence system service; and

providing information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

An example embodiment of the invention includes an apparatus, comprising:

at least one processor;

at least one memory including computer program code;

the at least one memory and the computer program code configured to, with the at least one processor, cause the coexistence manager at least to:

register coexistence information services to a wireless network, wherein decisions concerning operational parameters of the wireless network are made by a wireless device belonging to the wireless network;

determine that the wireless network has one or more neighboring wireless networks;

receive a satisfaction level indication for the wireless network, the satisfaction level indication representing how satisfied the wireless network is with current communication resources; and

notify one or more network controllers serving the one or more neighboring wireless networks of the registered service type and the satisfaction level indication of the wireless network.

An example embodiment of the invention includes an apparatus, comprising:

the at least one memory and the computer program code configured to, with the at least one processor, cause the coexistence manager at least to:

receive one or more reports from the one or more network controllers, including an indication of a type of coexistence system service of the one or more neighboring wireless networks as being the coexistence information services or a coexistence management service wherein one or more network controllers make decisions concerning operational parameters of the wireless network;

receive a request from the control node associated with the wireless network, inquiring what portion of neighboring networks use a type of coexistence system service; and

provide information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

An example embodiment of the invention includes an apparatus, comprising:

receive operational parameters of the wireless network comprising bandwidth, utilization, maximum operation power, and antenna configuration; and

notify one or more network controllers serving the one or more neighboring wireless networks of the operational parameters of the wireless network.

An example embodiment of the invention includes an apparatus, comprising:

at least one processor;

at least one memory including computer program code;

the at least one memory and the computer program code configured to, with the at least one processor, cause the coexistence manager at least to:

register coexistence management services to a wireless network, wherein decisions concerning operational parameters of the wireless network are made by cooperative resource allocation between network controllers serving one or more neighboring wireless networks;

determine that the wireless network has one or more neighboring wireless networks;

determine that one or more of the neighboring wireless networks is registered to coexistence information services;

receive a satisfaction level indication of the one or more neighboring wireless networks registered to coexistence information services, the satisfaction level indication representing how satisfied the one or more neighboring wireless networks registered to coexistence information services is with current communication resources; and

account for the satisfaction level indication of the one or more neighboring wireless networks in resource allocations to the wireless network registered to coexistence management services.

An example embodiment of the invention includes an apparatus, comprising:

the at least one memory and the computer program code configured to, with the at least one processor, cause the coexistence manager at least to:

receive one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service; and

reduce a probability of including a neighboring wireless network in reallocation of resources if the satisfaction level indication of the neighboring wireless network indicates that the neighboring wireless network is satisfied and the service type is the coexistence information services.

An example embodiment of the invention includes an apparatus, comprising:

the at least one memory and the computer program code configured to, with the at least one processor, cause the coexistence manager at least to:

receive one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service;

receive a request from the control node associated with the wireless network, inquiring what portion of neighboring networks use a type of coexistence system service; and

provide information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

An example embodiment of the invention includes a computer program product comprising computer executable program code recorded on a computer readable storage medium, which performs the above methods.

The embodiments of the invention enable wireless resource sharing between heterogeneous wireless networks to enable coexistence of secondary networks.

### DESCRIPTION OF THE FIGURES

FIG. 1 is an example system architecture diagram according to an embodiment of the present invention, illustrating a wireless metropolitan area network's coverage area overlapped by a wireless local area network and the reallocation of channels from the wireless local area network to the TV band white space.

FIG. 1A is an example system architecture according to an embodiment of the present invention, illustrating an example relationship between the network controller or coexistence manager, the primary database, and the coexistence network element Coexistence Discovery & Info Server (CDIS). A network of distributed coexistence managers may communicate with one another over the Internet, in an example embodiment of the invention.

FIG. 1B is an example functional block diagram according to an embodiment of the present invention, illustrating an example TV white space wireless device including the network controller or coexistence manager and the control node or coexistence enabler for a network. The device may be configured to operate in additional RF spectrum white space bands wherein there are no primary user radios operating in the neighboring wireless networks.

FIG. 1C is an example functional block diagram according to an embodiment of the present invention, illustrating the IEEE 802.11 WLAN AP and TVWS device STA1, which includes the network controller or coexistence manager and the control node or coexistence enabler, communicating over the Internet with the primary database and the coexistence network element Coexistence Discovery & Info Server (CDIS).

FIG. 1D is an example network diagram according to another embodiment of the present invention, illustrating the IEEE 802.11 WLAN AP and TVWS device STA5, which includes the control node or coexistence enabler, communicating over a backhaul wireline and/or internet link with the network controller or coexistence manager.

FIG. 1E is an example frequency band diagram illustrating an example TDMA coexistence frame 22 in sub-band 12 in the FCC dedicated TV band white space of 470-806 MHz, an example TDMA coexistence frame 24 in sub-band 14 in the FCC dedicated TV band white space of 54-88 MHz, and an example TDMA coexistence frame 26 in sub-band 16 in the earth station-to-satellite locally unused white space band 2.025 GHz to 2.110 GHz, according to an embodiment of the present invention.

FIG. 1F is an example frequency band diagram illustrating an example TDMA coexistence frame 28 in sub-band 18 in the TV band white space locally unused by licensed TV broadcasters in the 174-204 MHz band, representing broadcast TV channels 7, 8, 9, 10, and 11 in the Richmond, Va. (USA) area, an example TDMA coexistence frame 22 in sub-band 12 in the FCC dedicated TV band white space of 470-806 MHz, and an example TDMA coexistence frame 26 in sub-band 16 in the earth station-to-satellite locally unused white space band 2.025 GHz to 2.110 GHz, according to an embodiment of the present invention.

FIG. 1G is an example map of the Richmond, Va. (USA) geographic area and an overlay of coverage areas for broadcast TV channels 7, 8, 9, 10, and 11, illustrating that there is a locally available TV band white space that is unused by licensed TV broadcasters in the 174-204 MHz band.

FIG. 1H is an example of the basic functionalities of the network controller or coexistence manager and the control node or coexistence enabler, according to an embodiment of the present invention.

FIG. 2A is an example network topology scenario where the network “B” needs more resources, according to an embodiment of the present invention.

FIG. 2B is an example of coexistence management of the several networks shown in FIG. 2A, according to an embodiment of the present invention.

FIG. 2C is an example arrangement of the control node or coexistence enablers for networks A through G, the network controller or coexistence managers serving the coexistence enablers, the primary database, and the coexistence network element Coexistence Discovery & Info Server (CDIS), according to an embodiment of the present invention.

FIG. 3 is an example Neighbor Discovery between CMs, according to an embodiment of the present invention.

FIG. 4 is an example Interferer Report from CM of Interferer Source network, according to an embodiment of the present invention.

FIG. 5A is an example content of a CM_Interferer_Report message, according to an embodiment of the present invention.

FIG. 5B is an example content of a TVBD radio environment information message, according to an embodiment of the present invention.

FIG. 6A is an example flow diagram 600 of operational steps of an example embodiment of the method carried out by a coexistence manager (CM) of FIG. 1A registering coexistence information services, according to an embodiment of the present invention.

FIG. 6B is an example flow diagram 650 of operational steps of an example embodiment of the method carried out by a coexistence manager (CM) of FIG. 1A registering coexistence management services, according to an embodiment of the present invention.

### DISCUSSION OF EXAMPLE EMBODIMENTS OF THE INVENTION

In the United States, the FCC has opened up 300 MHz to 400 MHz of white spaces for unlicensed use that became unused after a federally mandated transformation of analog TV broadcasting to digital TV broadcasting. However, the FCC has prohibited unlicensed use of white spaces from interfering with existing licensed uses, including digital TV stations, low power TV stations, cable TV headends, and sites where low power wireless microphones are used. Various proposals have been made for unlicensed use of the white spaces left by the termination of analog TV, for example rural broadband deployment, auxiliary public safety communications, educational and enterprise video conferencing, personal consumer applications, mesh networks, security applications, municipal broadband access, enhanced local coverage and communications, fixed backhaul, and sensor aggregation for smart grid meter reading.

Coexistence standards are currently being developed to enable two or more independently operated wireless networks or devices using any radio technologies adapted for TV white space frequency bands, to access the same TV white space frequency band in the same location without mutual interference. Although the description herein is primarily related to TV white space frequency bands, embodiments of the invention are applicable to any type of white space environment having temporary or long term unused frequencies.

The IEEE 802.19 Working Group is currently defining coexistence rules for heterogeneous secondary networks. An example embodiment of the invention enables coexistence between heterogeneous secondary networks and coexistence between secondary networks and primary networks that are required to be protected. Primary networks and users are incumbent users of the selected frequency band that have a form of priority access to the band. Primary networks include networks operating in FCC licensed bands, such as for commercial radio and television broadcasting. Secondary networks and users are allowed to use the selected band only if there are resources that are not used by the primary users. Secondary networks include any broadband networks operating unlicensed in the TV white spaces (TVWS) and using transmission devices that comply with the FCC requirements for TV Band Devices (TVBDs). Fixed TVBD devices and portable TVBD devices (a type of master device) that are capable of initiating networks in TVWS must include geo-location and query a database to determine allowed channels. Portable TVBD devices that are not capable of initiating a network, operate under control of master devices. There are specific FCC requirements that apply to a client type of portable device, for example, on FCC ID verification and control signal reception from the master device. Additionally, the FCC rules allow for devices that only sense the RF spectrum (sensing-only devices). Those devices need not access geo-location data or a database, but they must include a spectrum sensing capability to identify TV and wireless microphone signals.

The FCC has adopted rules to allow unlicensed radio transmitters to operate in the broadcast television spectrum at locations where that spectrum is not being used by licensed broadcasters. The FCC required the use of geolocation to establish the location of the unlicensed transmitter and a database of TV bands use by licensed broadcasters organized by their geographic coverage areas, to enable the unlicensed transmitter to know where local TV band white spaces may be available. In the case of sensing-only devices, the FCC required the use of spectrum sensors in the unlicensed transmitter to detect the presence of the incumbent, primary TV broadcaster's signal in the local TV band white space to identify channels free from the incumbents. A primary user in such a local TV band white space would be an incumbent TV broadcaster licensed to operate in that band, but in those geographic areas where there are no licensed incumbent TV broadcasters in operation, other unlicensed secondary users may make use of that band.

Other RF spectrum white spaces may be locally unused in certain geographic areas, such as the frequency allocations from maritime radio in landlocked areas remote from the sea. A primary user in such a maritime radio band would be a maritime radio licensed to operate in that band, but in those geographic areas where there are no licensed maritime radios in operation, other unlicensed secondary users may make use of that band. Similarly, locally unused RF spectrum white spaces may be present in certain geographic locations, such as the frequency allocations from 2.025 GHz to 2.110 GHz for earth stations to transmit to communications satellites, in areas remote from such earth stations. A primary user in such a satellite earth station radio band would be a satellite earth station licensed to operate in that band, but in those geographic areas where there are no satellite earth stations in operation, other unlicensed secondary users may make use of that band.

Active coexistence between secondary networks using the TV band white spaces may require new techniques for fairly sharing the available bandwidth among different heterogeneous secondary networks and accord the required preference for primary users of the band. Such new techniques may require some form of communication between the secondary networks to enable a fair usage of the local spectrum. An example embodiment of the invention provides a coexistence manager of a secondary network that requires additional resources, to evaluate what may be a fair spectrum resource allocation between secondary networks in the same area. Based on the result of the evaluation, the coexistence manager of the requesting secondary network may either enable the secondary network to start using the additional resources or terminate the resource request process without further communication to its neighbors if there is no fair way to get more resources. An example embodiment of the invention provides a starting point for secondary network internal evaluation process to define a fair share of resources to each secondary network, taking into account that on an average, each node pair in the secondary network should potentially get the same amount of resources.

An example embodiment of the invention applies coexistence rules to enable heterogeneous secondary networks to share available resources in a fair manner and not cause harmful interference to primary networks. An example embodiment of the invention enables the dynamic allocation in TV white spaces (TVWS), of different networks with different standards in different available channel situations. An example embodiment of the invention determines whether the allocation analysis needs to be applied to all real neighbors.

An example embodiment of the invention is disclosed for independent wireless resource sharing on a fair basis to enable selecting the most suitable coexistence between wireless networks.

An example embodiment of the invention includes a hierarchical resource request process that enables reallocation of radio resources in a coexistence band. When new resources are requested by a network, a search is made for free resources in the coexistence band. If this does not succeed, a check is made for any allocated but unused resources in the coexistence band that have been advertised by neighboring networks in the same network allocation group. If there are insufficient advertised resources, then the allocation of resources in neighboring networks is analyzed and compared with the requesting network's need for network resources. There are two graduated stages to the analysis. In an example light analysis stage, an analysis of the allocation of resources is limited to neighboring networks within the same network allocation group as the requesting networks. In a more extensive analysis stage, all of the neighboring networks are analyzed. In this manner, a more complete resource reallocation may be achieved.

An example embodiment of the invention includes the steps to check if there is a free channel or if there are enough advertised resources. The order of these two steps may be reversed and optionally, either one of these two steps may be skipped.

An example embodiment of the invention includes a resource reallocation that enables heterogeneous and unlicensed spectrum users to agree and negotiate on spectrum use to better coexist with each other.

Depending on the wireless environment state, including whether there have been any major changes in the local area of a wireless network after a previous resource allocation, the network needing more resources may initiate either a light resource request process directed only to the networks in the same network allocation group or a more extensive resource request process directed to all networks within interference range. This selective possibility brings more stability to environment when resource needs are varying.

According to at least one embodiment of the present invention, independent wireless resource sharing is achieved on a fair basis to enable selecting the most suitable coexistence between wireless networks.

Radio resource allocations may be changed when a network sees a clear need for a reallocation from its perspective. Each network has a view of its own and its real neighbors' allocations and environmental state based on spectrum mapping, for example. This information may be one of several factors in performing the radio resource allocation analysis.

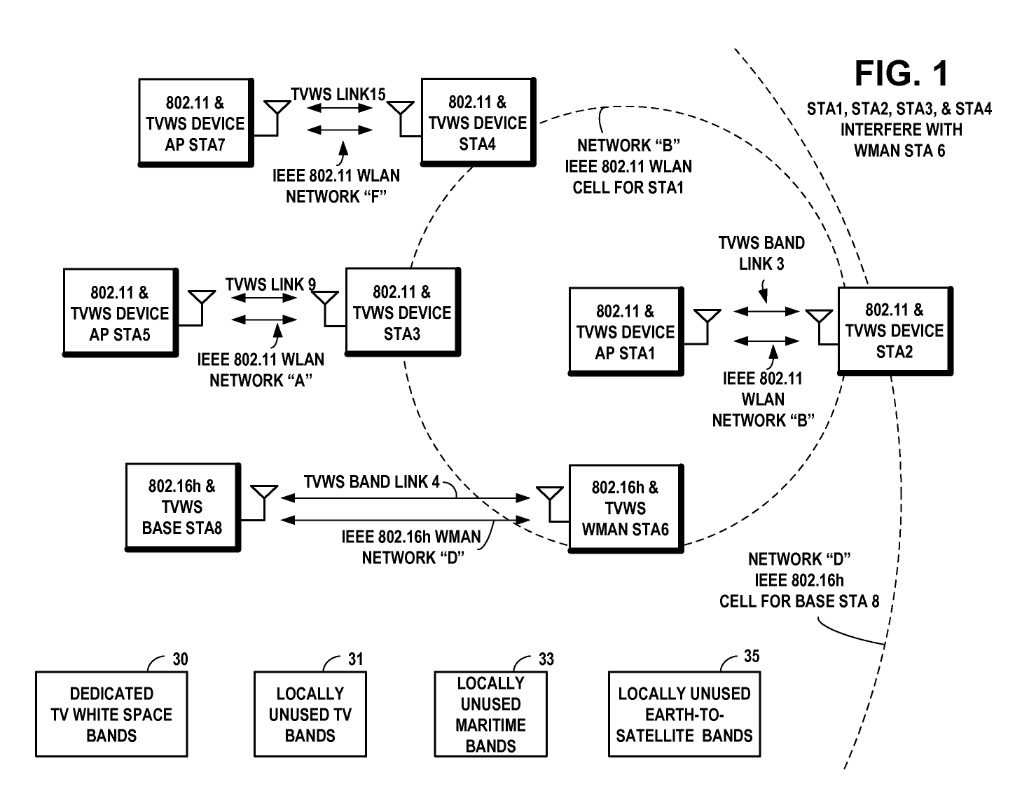

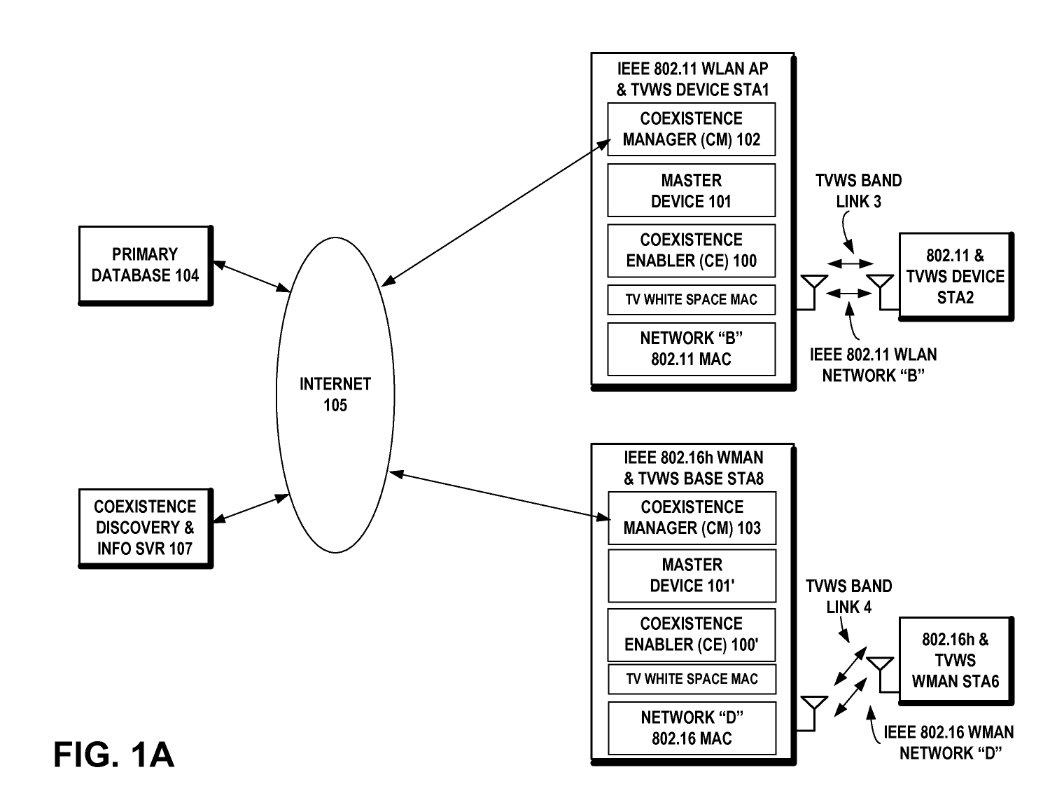

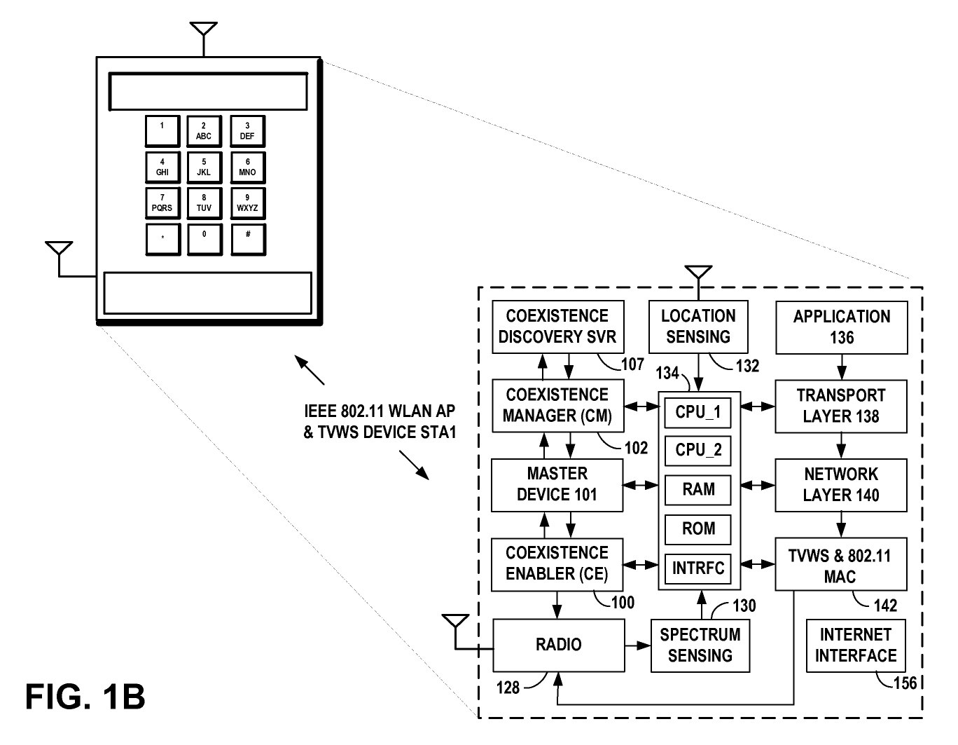

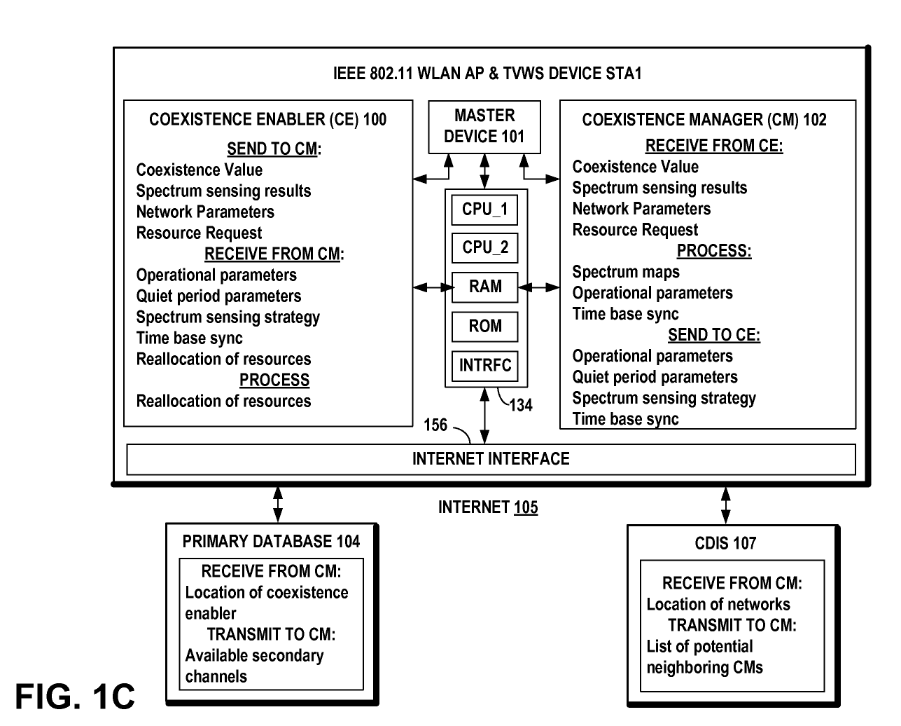

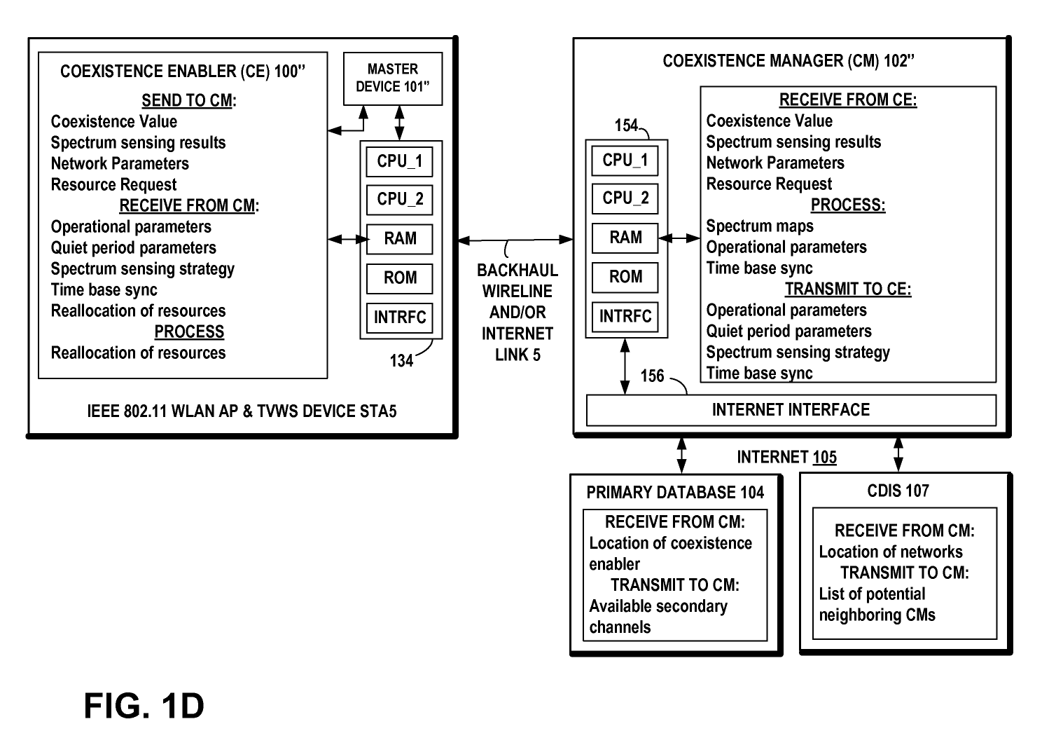

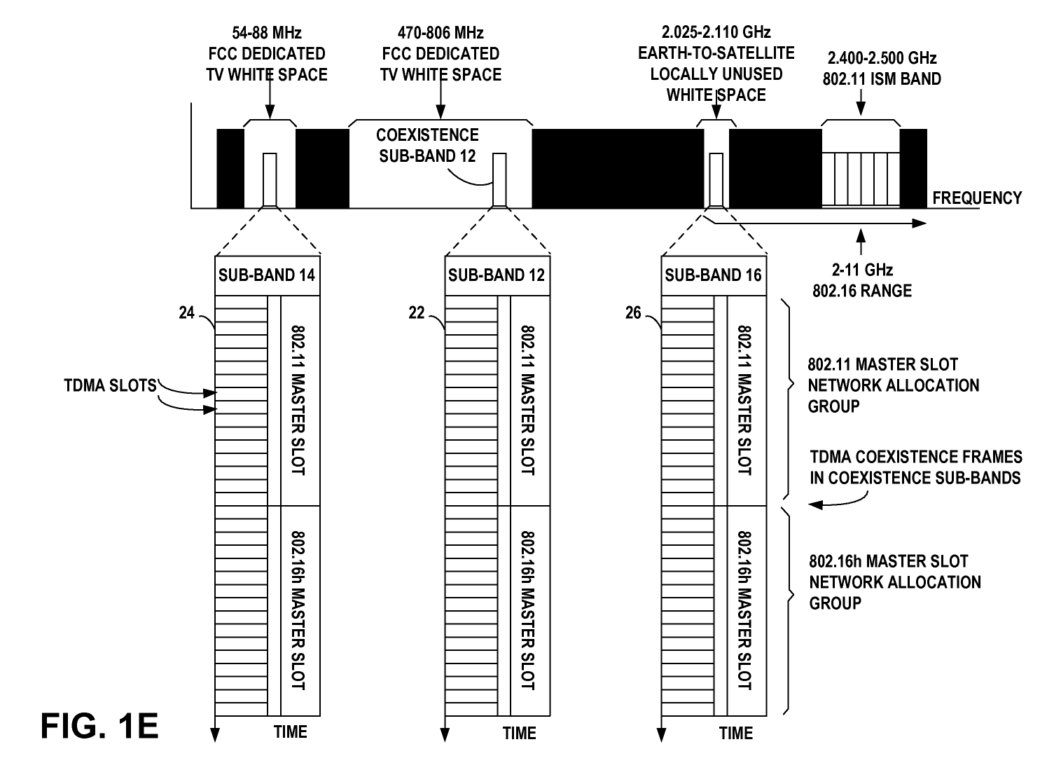

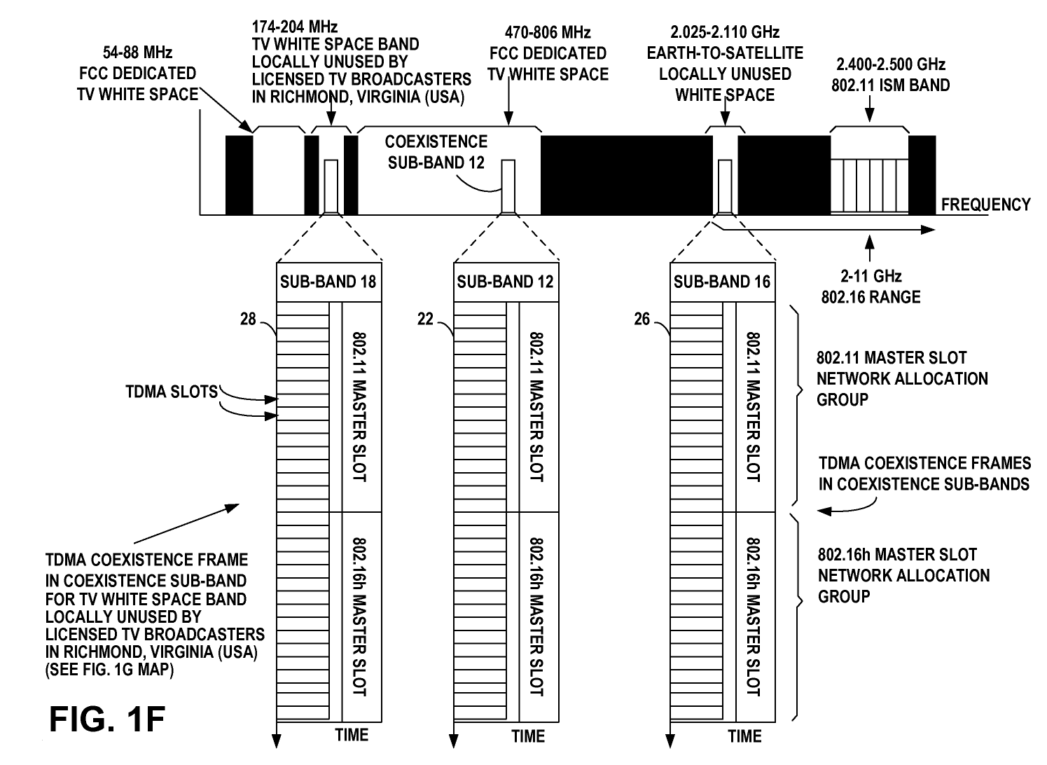

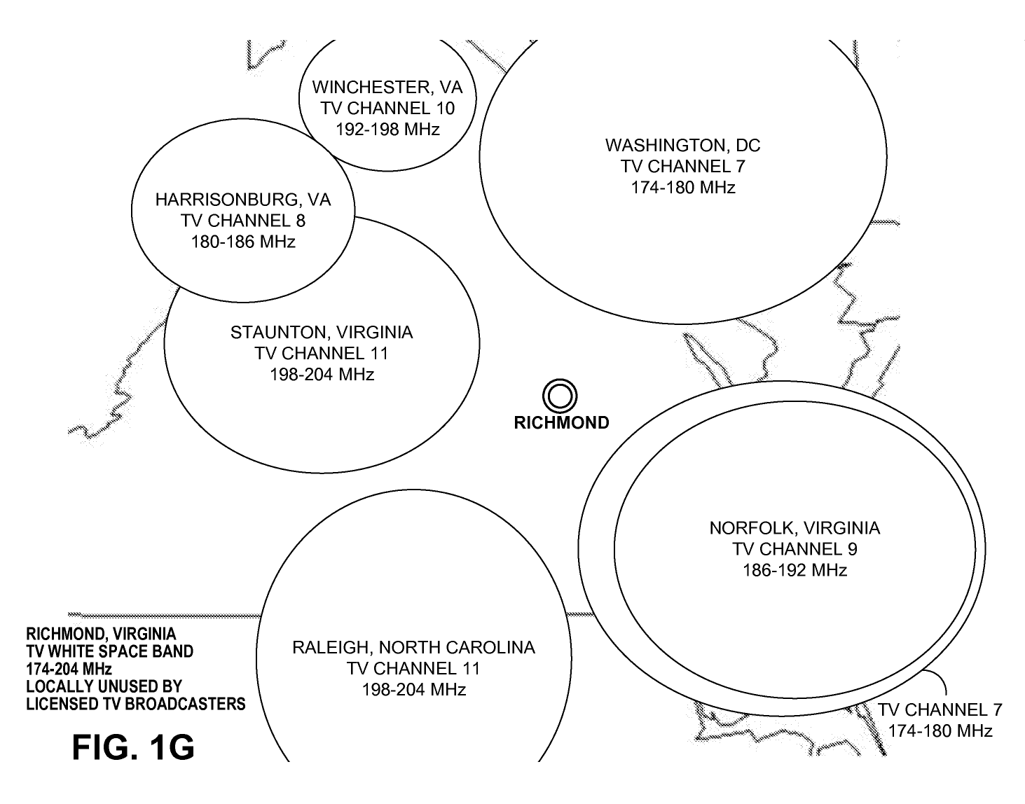

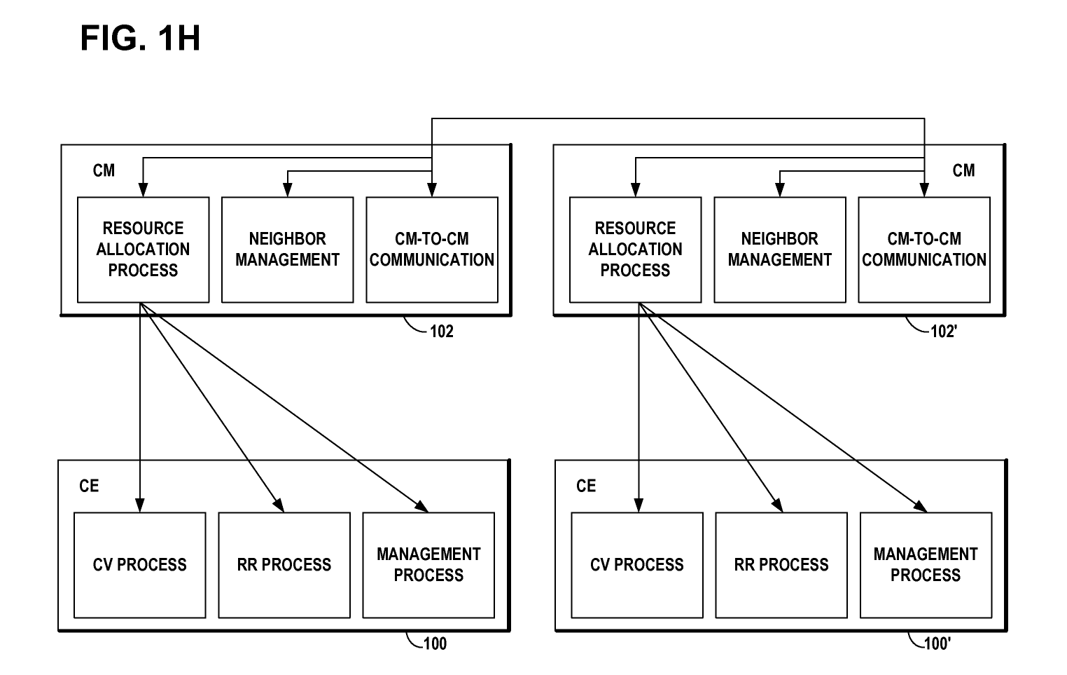

FIG. 1 is an example system architecture diagram according to an embodiment of the present invention, illustrating the coverage of an IEEE 802.16h wireless metropolitan area network (WMAN) cell overlapped by an IEEE 802.11 wireless local area network (WLAN) cell. An IEEE 802.16h WMAN STA 6 exchanges wireless broadband messages with an IEEE 802.16h WMAN base station 8 in a WMAN network “D”. The WLAN access point STA1 exchanges wireless broadband messages with an IEEE 802.11 client device STA2, such as a personal computer over the WLAN network “B”. Both IEEE 802.11 WLAN access point STA1 and the IEEE 802.11 client device STA2 interfere with the IEEE 802.16h WMAN STA 6. For example, WLAN devices are typically designed for better resistance to saturation than WMAN devices, since WMAN devices must be more sensitive to attenuated signals received over a greater range than are WLAN devices and are therefore more sensitive to interference. Both the WLAN access point STA1 and IEEE 802.11 client device STA2 are TV white space (TVWS) devices, meaning that they are equipped to communicate over the dedicated TV band white space 30. Similarly, the IEEE 802.16h WMAN STA 6 and the IEEE 802.16h WMAN base station 8 are TV white space (TVWS) devices, meaning that they are equipped to communicate over the dedicated TV band white space 30. Thus, the interference of the IEEE 802.16h WMAN STA 6 by both the IEEE 802.11 WLAN access point STA1 and the IEEE 802.11 client device STA2 may be ameliorated by reallocating the IEEE 802.11 frames from the WLAN network “B” to the TV band white space link 3. The dedicated TV band white space 30 may be shared by many terminals using diverse communication protocols. For example, if the WMAN network “D” reaches its maximum capacity, the traffic congestion may be alleviated by reallocating the IEEE 802.16h frames from the WMAN network “D” to the TV band white space link 4. A third device, STA3, is present in the 802.11 WLAN cell of STA1, as part of a neighboring network “A” with 802.11 AP STA5. STA3 is also a TV white space (TVWS) device and has reallocated frames on TVWS link 9 communicating over the dedicated TV band white space 30. A fourth device, STA4, is present in the 802.11 WLAN cell of STA1, as part of a neighboring network “F” with 802.11 AP STAT. STA4 is also a TV white space (TVWS) device and has reallocated frames on TVWS link 15 communicating over the dedicated TV band white space 30.

Other network topologies may make use of example embodiments of the invention, for example more heterogeneous networks, each of which has an Internet connection that they may use first for neighboring network discovery.

FIG. 1 also shows three example white space bands locally unused by licensed primary users of their respective RF spectrum white spaces, which may be used by the WLAN access point STA1 or client device STA2, operating as unlicensed secondary users. TV band white space 31 is locally unused by licensed TV broadcasters. Maritime radio band 33 is locally unused by licensed maritime band radios. Earth station-to-satellite radio band 35 is locally unused by licensed earth station radios. An example of a TV band white space 31 locally unused by licensed TV broadcasters is the 174-204 MHz band, representing the local absence of broadcast VHF TV channels 7, 8, 9, 10, and 11. If there were a local absence of licensed broadcasters in TV band white space 31, on VHF TV channels 7, 8, 9, 10, and 11, which would otherwise interfere with the WLAN access point STA1 or client device STA2, then they could operate as unlicensed secondary users and make use of TV band white space 31. If either STA1 or STA2 were to detect a signal transmitted from a neighboring TV broadcaster in band 31, then they would have to relinquish their use of the TV band white space 31 and make a resource request, in accordance with an example embodiment of the invention.

A maritime radio operates in a number of licensed frequency allocations and is a primary user in the maritime radio band 33. If there were no licensed maritime radios in operation that would interfere with the WLAN access point STA1 or client device STA2, then they could operate as unlicensed secondary users and make use of maritime radio band 33. If either STA1 or STA2 were to detect a signal transmitted from a neighboring maritime radio, then they would have to relinquish their use of the maritime band 33 and make a resource request, in accordance with example embodiments of the invention.

A satellite earth station transmits to satellites in licensed frequency allocations from 2.025 GHz to 2.110 GHz and is a primary user in the earth-to-satellite band 35. If there were no licensed earth station radios in operation that would interfere with the WLAN access point STA1 or client device STA2, then they could operate as unlicensed secondary users and make use of earth-to-satellite radio band 35. If either STA1 or STA2 were to detect a signal transmitted from a neighboring earth station radio, then they would have to relinquish their use of the earth-to-satellite band 35 and make a resource request, in accordance with example embodiments of the invention.

Although the description herein is primarily related to TV white space frequency bands, embodiments of the invention are applicable to any type of white space environment having temporary or long term unused frequencies.

FIG. 1A is an example system architecture according to an embodiment of the present invention, illustrating an example coexistence system that is a network of coexistence managers, a primary database, and a Coexistence Discovery & Info Server (CDIS). The coexistence system of distributed coexistence managers 102 and 103 may communicate with one another over the Internet, in an example embodiment of the invention. According to this example embodiment, the control node or coexistence enabler 100 in the IEEE 802.11 WLAN access point STA1 for a Network “B” is collocated with the TVWS coexistence manager 102. Master device 101 is registered through the control node or coexistence enabler 100 to the network controller or coexistence manager 102.

The coexistence enabler 100′ in the IEEE 802.16h WMAN base STA8 for a Network “D” is collocated with the TVWS coexistence manager 103. The distributed coexistence managers 102 and 103 may communicate over the Internet with the TVWS primary database 104 and the TVWS coexistence network element Coexistence Discovery & Info Server (CDIS) 107, in an example embodiment of the invention. Master device 101′ is registered through the control node or coexistence enabler 100′ to the network controller or coexistence manager 103.

The key functions of Coexistence Enabler (CE) are to obtain information required for the coexistence from the TV band device (TVBD), and to reconfigure TVBD operation according the coexistence decisions which are received from the Coexistence Manager (CM). The collected information covers the capabilities and the resource need of the TVBD network, and the characteristics of the radio environment. The CE resides in a TVBD, e.g. in an access point, base station, or mesh point.

Coexistence Manager is the main decision maker of the coexistence system. It discovers and solves the coexistence conflicts of the networks operating in the same area. A CM serves one or more networks. Depending on the deployment, it resides either in a TVBD or in the network entity. In independent networks it may reside in a TVBD. The CM discovers the interfering networks and their CMs, and shares information with other CMs. Based on the collected information it reconfigures the operation of its own network/s, but also performs resource reallocation for the whole neighborhood, as needed.

The coexistence system includes a network of coexistence managers (CM), each of which serves one or more coexistence enablers (CE). The coexistence enabler is responsible for obtaining information required for the coexistence of the TV band device (TVBD) and for reconfiguring TVBD operation according the coexistence decisions that are received from the Coexistence Manager (CM).

The coexistence system, i.e., the network of coexistence managers, primary database, and CDIS, has two services to provide: the coexistence management service and the coexistence information service. A master TVBD device may register with either of the services. The coexistence system determines resource usage for those master TVBD devices and their networks that are registered with the coexistence management service. Alternately, the master TVBD device that has registered with the information service, only makes the decisions on resource usage by itself.

In an embodiment of the invention, Master device 101 is registered through its control node or coexistence enabler CE 100 to coexistence information services associated with its network controller or coexistence manager CM 102, to provide information characterizing the master device's satisfaction with the current resources available to its associated network B. Master device 101′ is registered through its control node or coexistence enabler CE 100′ to coexistence information services associated with its network controller or coexistence manager CM 103, to provide information characterizing the satisfaction of master device 101′ with the current resources available to its associated network D.

In an embodiment of the invention, Master device 101 is registered through its control node or coexistence enabler CE 100 to its network controller or coexistence manager CM 102, to inquire of its network controller or coexistence manager CM 102, what portion of neighboring networks use information/management services. Master device 101′ is registered through its control node or coexistence enabler CE 100′ to its network controller or coexistence manager CM 103, to inquire of its network controller or coexistence manager CM 103, what portion of neighboring networks use information/management services. In an embodiment of the invention, Master device 101 may also get more detailed information about its neighbors' service use, including a list of neighboring networks and for each network, an indication as to whether the network is registered to the coexistence management service or to the coexistence information service.

In an embodiment of the invention, each network controller or coexistence manager CM has a set of rules concerning what to assume about the radio resource usage of those master devices associated with neighboring networks that use only the information services.

Coexistence Discovery and Information Server (CDIS) assists the CMs in the neighbor discovery. It keeps a record of the registered CMs and location of the networks they serve, and provides a list of candidate or potential neighbors for a CM which initiates the neighbor discovery for its network. CDIS may also store some other information relevant for coexistence, for example, statistics of the spectrum use and the portion of networks that use either the information or the management services.

Although the description herein focuses on cases in which only Master devices are registered through its control node or coexistence enabler CE to its network controller or coexistence manager CM, the design allows any kind of device, including client devices, to be registered through a control node or CE to a network controller or CM for coexistence management and information system services.

Service Definitions for the IEEE 802.19.1 Standard

The basic rule in the service definitions for the IEEE 802.19.1 standard is that services are provided by the coexistence system (i.e. the IEEE 802.19.1 system) and they are consumed by TV Band Devices (TVBDs). According to the system model, a TVBD interfaces to a coexistence system through a coexistence enabler CE. A TVBD and its associated coexistence enabler CE (CE/TVBD) do not provide services to the system. A coexistence enabler CE becomes a part of the system once it starts using the system's services, after registering or subscribing to those services. Once that has happened, the coexistence enabler CE is obligated to provide information to the system, which information is used by the system in its system services. Thus, a coexistence enabler CE and its associated TVBD need to provide information to the system in order to use the services of the system. The system also has the capability to request information (for example, measurements) from the CE/TVBD combination and the coexistence enabler CE may be configured to provide information on certain conditions (for example, triggering rules for information provisioning and filtering rules). But, the CE/TVBD combination does not provide services; it is a user of services. An exception is the Basic/Support Services that are individual support services provided by substantially all the elements to facilitate system configuration and management and the use of information services and management services.

Definitions of the coexistence system (i.e. the IEEE 802.19.1 system) services are as follows:

Service Set [1]: Coexistence Management Services
[a] Provided by the coexistence system, e.g. by CM.
[b] A CE subscribes to this service when the TVBD associated to it wants the coexistence system to make decisions on the operational parameters.

Service Set [2]: Coexistence Information Services
[a] Provided by the coexistence system, e.g. by CM.
[b] A CE subscribes to this service when the TVBD associated to it wants to make its own decisions on the operational parameters.

Basic/Support Coexistence System Services
[a] This service provides the basic functionality to configure and manage elements, inter-element communication and service usage.
[b] Comprises of a set of individual services from which some need to be supported by all the entities and some are entity dependent.
The Basic/Support services are bidirectional (CE-CM) services from which some may be available for a CE without separate subscription.

Different Types of Coexistence Management System Services

Although the IEEE 802.19.1 Specification is planned to provide a complete coexistence service to secondary networks/nodes operating within White Space environments, there will be circumstances where not all secondary networks use the service in a way that coexistence manager (CM) entities are defined in the IEEE 802.19.1 Specification, to calculate and provide the parameters for operation for all of the networks/nodes in the area controlled/managed by a particular CM.

When a coexistence manager (CM) serves networks/nodes that are registered to the coexistence management services and the networks/nodes have at least one coexistence enabler (CE) of a neighbor network that is using only the coexistence information service, the CM needs to decide how to take into account the networks/nodes for which it may not be able to determine operational parameters. If all the neighbor networks/nodes are using the coexistence management service, the CM may be sure that the networks operate as per the parameters given to them.

The Satisfaction Indicator

In an embodiment of the invention, the coexistence manager (CM) may use a Satisfaction Indicator provided by the Master Device, to enable the CM to draw valid inferences concerning the radio resource usage of those neighbor networks/devices that use only the coexistence information services and not the coexistence management services, in order for the CM to make appropriate decisions on the resources of the neighbor networks/devices that use coexistence management services.

The satisfaction indicator may be used by the CM as an indicator to define how static or dynamic the neighbor network is expected to be, which is using only the coexistence information service. If the neighbor network/node is satisfied with its resource situation, the CM may consider that the neighbor network/node will continue using the resources it is currently is using, without the neighbor network making any changes in its behavior. On the other hand, if the neighbor network/node is not satisfied with its current resourcing, the CM may take this into account when reallocating resources between networks/nodes using the entire CM resource allocation service.

Example Implementation of Satisfaction Level Indication

In an embodiment of the invention, a coexistence enabler (CE) that is registered to coexistence information services (service set 2) provides the satisfaction level indication. A CE that is registered to coexistence management services (service set 1) may provide satisfaction level indication.

In an embodiment of the invention, the satisfaction level indication may be described in simple form, for example by one bit, with the following values:

0=no current aim to change channel (i.e. satisfied)

1=aim to change channel (i.e. not satisfied with the resources)

Alternatively, the satisfaction level indication may be described with a parameter/element that allows for more values for the indication and more fine-grained indication of the satisfaction level. For example, the satisfaction level indication may be described by one octet with value range from 0 through 255, in which the lower value indicates the higher satisfaction level. In other words, value 0 would stand for “no current aim to change channel (i.e. satisfied)” and value 255 would stand for “aim to change channel (i.e. not satisfied with the resources)”.

The CE informs the coexistence system that the TVBD's resource use has changed. The CM may request the resource use information and may configure the CE to send automatic updates.

Message From CM to CE: CE_resource_use_req

Message From CE to CM: CE_resource_use_rsp
Bandwidth (start channel+bandwidth)
Utilization (used time-% in the bandwidth)
Max operation power
Antenna configuration
Satisfaction level

Example Implementation of Neighborhood Service Set Selection Indication

In an embodiment of the invention, a master device makes the decision on choosing either the coexistence management or the coexistence information service for its CE. One basis for the selection may be the usage of either service set among the neighboring networks. For example, if all other networks in the area use the service set 2 for Coexistence Information Services, it is probably not very useful for the network to choose the service set 1 for Coexistence Management Services.

As part of the information delivery, a CM may automatically, or by request, provide the information to the CE of the used service set per neighboring network. This may be indicated with one bit associated with each neighbor, the values being as example:

0=this neighboring network uses service set 1 for Management Services

1=this neighboring network uses service set 2 for Information Services

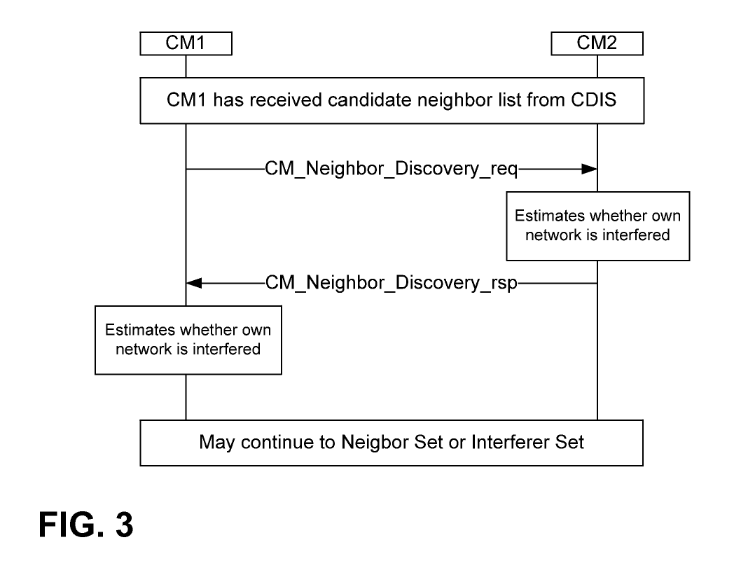

After a CM has received a list of candidate neighbors from the CDIS, for a network associated to a CE it serves, it may connect directly to the CMs of the candidate neighbor networks to discover more information of them. This is presented in FIG. 3. In the message Neighbor_Discovery_req, the CM1 shares information of the network, which may interfere the candidate neighbor, and in the message Neighbor_Discovery_rsp, the CM2 shares information of the candidate neighbor network. In fact the network that is served by the CM1 and on which the CM2 receives information in the Neighbor_Discovery_req message, becomes a candidate neighbor for the candidate neighbor served by the CM2. Both CMs evaluate whether their networks are interfered by their candidate neighbor. The CM2 includes the result of its estimation in the message Neighbor_Discovery_rsp (e.g. source_to_destination_interference parameter is set to TRUE or FALSE). The evaluation whether the candidate network interferes may be based on estimate by the CM and/or measurements performed by the networks.

For example, the message Neighbor_Discovery_rsp from other CMs serving neighbor networks in the area may indicate which neighbor networks use the service set 2 for Coexistence Information Services and which use the service set 1 for Coexistence Management Services. The message Neighbor_Discovery_rsp from other CMs serving neighbor networks in the area may also indicate the satisfaction level indication of each neighbor network.

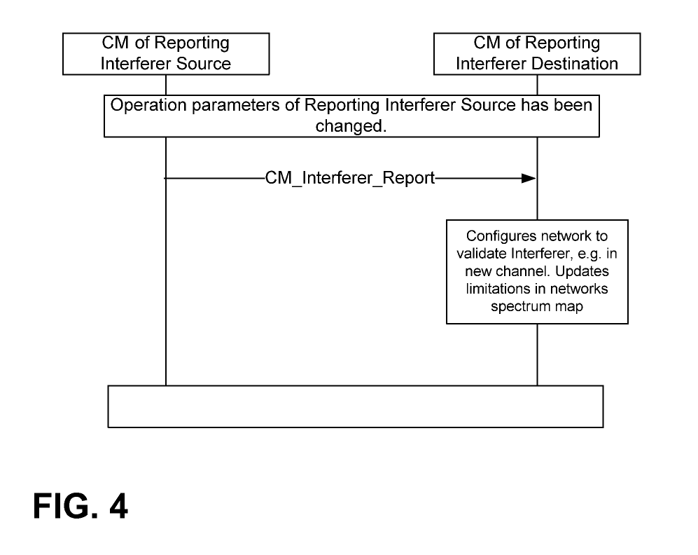

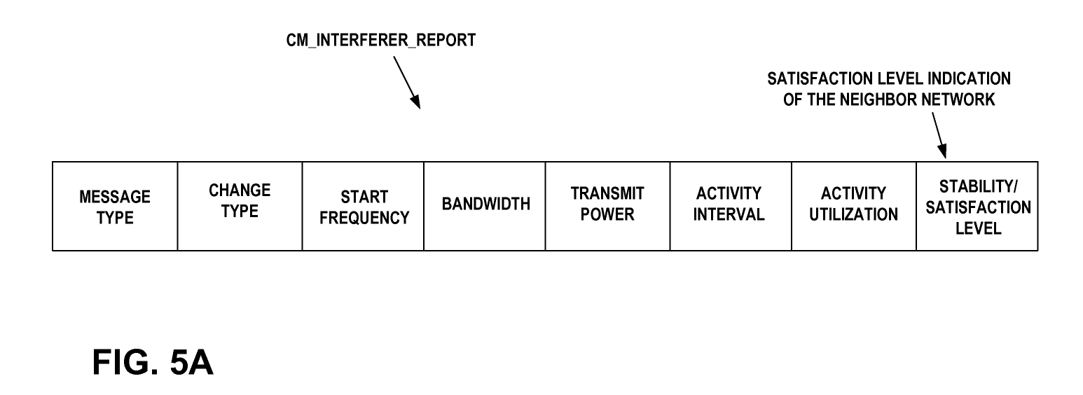

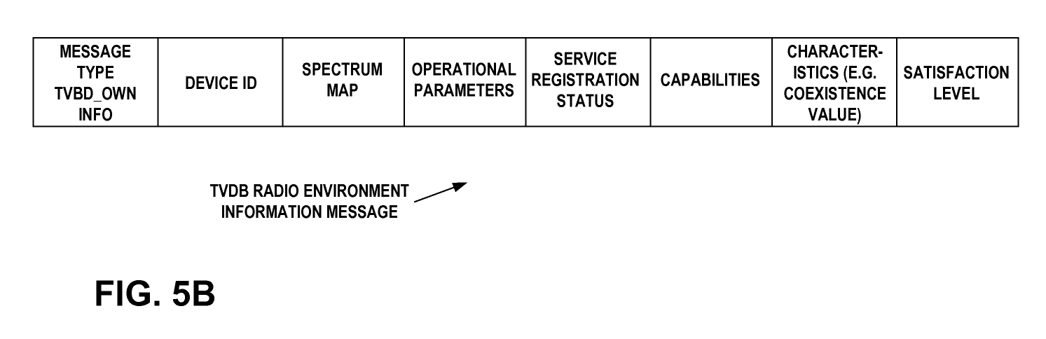

Once the networks are set as Reporting Interference Destination and Source neighbor networks, the CM of Reporting Interference Source may start sending information of its operational changes to the CM of Reporting Interference Destination, as presented in FIG. 4. Interferer report is sent from the CM of Reporting Interferer source to the CM of Reporting Interference Destination to indicate the changes in the operation change of the Source network. Such change may be for example, channel switch, change of operating bandwidth, change in operation interval or utilization, change in transmission power, and the stability/satisfaction level. CM of the Reporting Interferer Source sends the change information in CM_Interferer_Report to the CMs of Reporting Interferer Destinations. The example of the content of the CM Interferer Report message is presented in FIG. 5A, where the satisfaction level indication of the neighbor network is shown as last field. The message may be sent as broadcast, multicast, or unicast transmission depending on the used transport between the CMs, and also on the amount of the Reporting Interferer Destinations.

In an example embodiment of the invention, a coexistence manager (CM), such as CM1, communicates:

a) service registration; and

b) satisfaction level

of each TVBD/CE it serves. The CM communicates this information to other CMs, for example CM2, that serve a TVBD/CE that have been determined to be either a neighbor or one-sided interferer.

In an example embodiment of the invention, the service registration information indicates whether the TVBD has registered to coexistence information or coexistence management service (or both). This information needs to be communicated to all the CMs serving neighbor networks. In embodiments, the information may be carried in a TVBD radio environment information message, as shown in FIG. 5B. In embodiments, the information may be carried in one field of a general information update message or as a part of spectrum map message.

In an example embodiment of the invention, the satisfaction level information may also communicated to all the CMs serving neighbor networks, if the own network is registered only to the coexistence information service, or only to the coexistence management service, or to both services. A CM has an obligation to keep neighbors updated on the satisfaction level of the network/TVBD the CM serves if the network/TVBD is registered to the coexistence management service only. In embodiments, the information may be carried in a TVBD radio environment information message, as shown in FIG. 5B. In embodiments, a common message may be used. In embodiments, this information may be embedded also to spectrum map, if so decided. In embodiments, this information may be communicated also to a one-sided interferer in a interferer report as described in FIG. 5A.

In an example embodiment of the invention, the CM maintains following kinds of radio environment information base for each TVBD_Own and transmits this information to other CMs in a TVBD radio environment information message shown in FIG. 5B:
TVBD_Own info: Device ID, Spectrum map, Operational parameters, Service registration status, Capabilities, Characteristics (e.g. Coexistence Value), Satisfaction level, etc.

For each member of each list following information is maintained:
Info: Information about the TVBD_Other, e.g. device ID, network type, operating parameters;
Obligations: What are obligations of the CM related to the TVBD_Other of this category? What is expected from the CM with respect to the TVBD_Other devices in this category?
Expectations: What are expectations of the CM related to the TVBD_Other of this category? What the CM expects to get/receive?
   Additional details of the information a CM may maintain and communicate to other CMs are provided below.

Example Implementation of CM's Resource Allocation in Mixed Service Environment

In an embodiment of the invention, a CM determines radio resources for a master device that uses the coexistence management services and the circumstance arises that at least one neighboring master device uses only coexistence information services. The CM will then assume that the neighbor network using only coexistence information services will not change its operating channel. The higher the satisfaction level value indicated by the neighboring network, the more probable it is that the network will not change its operating channel. The CM also assumes these channels will remain unchanged after it has determined a new allocation of resources for the master device and its neighbor networks that use the coexistence management services.

Reallocation of Resources

If there has been a major change in the network neighborhood after a previous resource allocation, resulting in there being not enough free or advertized resources are available to satisfy the requirements of Network “B”, the coexistence enabler 100 and coexistence manager 102 may initiate a resource reallocation process. The resource reallocation process may be either a light resource request process directed only to the networks in the same network allocation group or a more extensive resource request process directed to all networks within interference range. This graduated analysis brings more stability to the network environment when resource needs are varying. Example steps in requesting a reallocation of resources are:
coexistence enabler 100 identifies excess resource need because of:
   Internal request
   Coexistence communication trigger
coexistence enabler 100 sends a Resource Request to its coexistence manager 102.
coexistence manager 102 analyses environment situation using
   Spectrum map (a separate process to keep updated)
coexistence manager 102 determines resource allocation process
   More extensive: change in number of available channels for secondary users or in number of secondary networks
   Light: other cases
coexistence manager 102 initiates resource allocation if coexistence enabler 100 is eligible or other suitable free resources available.

Examples of a network allocation group include self-coexistence scenarios where two systems (a base station or access point and the associated mobile station or STA) use the same technology and may share a frequency channel. For example, an IEEE 802.11 WLAN may coexist with another IEEE 802.11 WLAN in sharing a TV band white space, if both systems use the same physical layer (PHY) technology and channel width. In another example, an IEEE 802.16h WMAN coexists with another IEEE 802.16h WMAN in sharing a TV band white space.

Other examples of a network allocation group include different IEEE 802 network technologies that may be time division multiplexed based on the IEEE 802.16h draft standard and are synchronized with a GPS clock or IEEE 1588 or IETF network time protocol clocks.

Neighboring networks may be identified to a local network, for example, by a coexistence manager transmitting a request to a server via an Internet connection. This request may inquire as to whether other networks are located proximate to the local network in an operational environment. The server may return information to the coexistence manager via the Internet informing the coexistence manager of the proximately-located networks.

The information provided by the server to the coexistence manager may comprise Internet addresses corresponding to potential coexistence enablers or coexistence managers that are managing wireless networks in the same operational environment as the local network. The coexistence manager uses these addresses to contact at least some of the coexistence managers of the potential networks via the Internet in order to request communication configuration and test information. The other networks may respond to these requests, and the coexistence manager may use the communication received configuration and test information to select a group of candidate networks. Candidate networks may be selected based on, for example, the distance from the local network to a potential network, transmission properties (e.g., transmission power of potential networks), etc. Information needed for candidate selection may be provided by potential networks to the local network or the coexistence manager via an Internet connection.

The local network may then initiate testing the group of candidate networks. Testing may comprise transmitting one or more wireless signals that should be receivable by the candidate networks. The coexistence manager may utilize testing results to select real neighbor networks from the group of candidate networks.

In an example embodiment of the invention, FIG. 1A shows the relationship between the control node or coexistence enabler 100 and the network controller or coexistence manager 102 in the TV white space (TVWS) WLAN access point STA1 and the distributed coexistence manager 103 in the TVWS base STAB. The coexistence enabler 100 has to obtain information required for coexistence from a traffic network or device representing it. This includes configuration and control of measurements. Also, the coexistence enabler 100 has to provide reconfiguration commands and control information to the Network “B” or the WLAN access point STA1, corresponding to coexisting decisions received from coexistence managers 102 and 103, respectively. The coexistence manager 102 is responsible for discovery of Coexistence Managers (CM)s 103 managing neighboring wireless networks, for example, and coexistence related information may be exchanged with them. The coexistence manager 102 assembles the needed information to make decisions of resource sharing among the Coexistence Managers (CM)s managing neighboring wireless networks.

The example system architecture of FIG. 1A shows the coexistence enabler 100 and coexistence manager 102 in the TV white space WLAN access point STA1 for a Network “B”. In the example shown, the TV white space (TVWS) WLAN access point STA1 includes a coexistence enabler 100 and coexistence manager 102, and is serving as an access point for the TVWS wireless device STA2 in the Network “B”, which may be, for example, an IEEE 802.11 WLAN. The IEEE 802.16h WMAN base STA 8 is also a TV white space (TVWS) wireless device and includes a coexistence enabler 100′ and coexistence manager 103, and communicates with the WMAN STA 6. IEEE 802.16h WMAN base station 8 is in the WMAN network “D”, which may be, for example, an IEEE 802.16h WMAN. The coexistence manager 102 handles resource requests from the coexistence enabler 100 in STA1. The coexistence manager 103 handles resource requests from the coexistence enabler 100′ in base STA 8. The TV white space (TVWS) WLAN access point STA1 in the Network “B” includes a Network “B” MAC and PHY to communicate over the Network “B”. The IEEE 802.16h WMAN base STA 8 in the Network “D”, includes a Network “D” MAC and PHY to communicate over the Network “D”. Each TV white space (TVWS) wireless devices STA1 in the Network “B” and STA 6 in the Network “D”, includes a TV white spaces MAC and PHY to communicate in channels in the TV white spaces band reallocated by the coexistence manager 102 and 103, respectively, without mutual interference. The coexistence enablers 100 and 100′ in STA1 and in base STA 8 send resource requests to the respective coexistence managers 102 and 103.

The example system architecture of FIG. 1A shows the coexistence manager 102 receiving a resource request from the coexistence enabler 100 in TV white space (TVWS) WLAN access point STA1. The coexistence manager 102 has received Spectrum sensing results and network parameters from the coexistence enabler 100 in device STA1. Network parameters may include specific user requirements (user load, QoS, priority, etc), aggregate spectral efficiency, etiquette (first come, first served, etc.), and user or network policies. The coexistence manager 102 accesses the primary database 104 to obtain available secondary channels in the TV band white space. The coexistence manager 102 accesses the coexistence network element Coexistence Discovery & Info Server (CDIS) 107 to obtain Potential neighbor networks' addresses. The coexistence manager 102 processes this data in conjunction with Spectrum maps, Operational parameters, and Time base sync, to determine a resource reallocation for the coexistence enabler 100 in device STA1. The coexistence manager 102 then sends to the coexistence enabler 100 in device STA1 the resource reallocation, including Operational parameters, Quiet period parameters, Spectrum sensing strategy, and Time base sync. The coexistence enabler 100 in device STA1 then controls the medium access control (MAC) to communicate in channels in the TV white spaces band reallocated by the coexistence manager 102, without interference from other networks sharing the same white space channels. A similar operation may be carried our by the coexistence manager 103 in conjunction with the coexistence enabler 100′ in base STA 8. A network of distributed coexistence managers 102 and 103 may communicate with one another over the Internet 105.

Although the description herein is primarily related to TV white space frequency bands, embodiments of the invention are applicable to any type of white space environment having temporary or long term unused frequencies.

FIG. 1B is an example functional block diagram according to an embodiment of the present invention, illustrating an example TV white space WLAN access point STA1 including the control node or coexistence enabler 100 for Network “B” and network controller or coexistence manager 102. Master device 101 is registered through the control node or coexistence enabler 100 to the network controller or coexistence manager 102. The example device STA1 includes a protocol stack for Network “B”, including the radio 128 and the Network “B” IEEE 802.11 MAC 142, which may be based, for example, on the IEEE 802.11 WLAN standard. The MAC 142 includes integrated TV white space features. The protocol stack may also include a network layer 140, a transport layer 138, and an application program 136. The example device STA1 includes a processor 134 that includes a dual core central processing unit CPU_1 and CPU_2, a RAM memory, a ROM memory, and an interface for a keypad, display, and other input/output devices. A location sensor 134, such as a GPS is included to establish the geographic location of the device STA1, and the location of the STA1 is reported to the network controller or coexistence manager 102. The coexistence enabler 100 sends resource requests to the coexistence manager 102. The MAC 142 includes integrated TV white space features to communicate using the radio 128 in channels in the TV white spaces band reallocated by the coexistence manager 102, without mutual interference. The spectrum sensor 130 senses the electromagnetic environment of the STA1 and reports it to the coexistence manager 102.

Control node according to an embodiment of the present invention, such as the CE 100 obtains information required for coexistence from TV Band Device (TVBD) network or device. This includes configuration and control of measurements performed by TVBD network or device. The CE forwards the collected information to its associated network controller, such as CM 102. The information may be formatted in standard format. Also, the CE provides reconfiguration commands and control information to TVBD network or device, corresponding to coexisting decisions received from the associated CM. The CE may reside in a TVBD device, e.g. in access point, base station, or mesh point. There is one CE in a network. It may collect the information from the other network nodes using radio standard specific means.

A network controller, such as the CM 102 is responsible for making the decisions on the spectrum resource sharing, providing information about the coexistence environment to CEs registered to the coexistence information services, discovery of other CMs controlling neighboring networks and coexistence related information exchange with them. The CM may serve one or more networks. It collects information from associated networks and configures it via a control node of a wireless network, such as CE 100. The CM may also obtain information from the TVWS database. From the collected information the CM constructs the spectrum map for the network, and calculates the amount of resources for which the network is eligible in the current spectrum environment. The information is used in spectrum allocation. The CM commands its CE(s) 100 based on the decisions it and its neighboring CMs have made. It is optional whether there is a hierarchy between CMs. The CM may reside in a TVBD device, or in the network.

The Coexistence Discovery and Information Server (CDIS) 107 assists the CMs 102 to discover possible coexistence conflicts of the networks it controls, and to discover the CMs with which the conflicts may be solved. The CDIS supports the discovery of CMs by keeping a record of the existing CMs and location of the networks they control. It provides a list of potential neighboring CMs for the CMs controlling new or moving networks. Such CDIS server is needed for discovering neighboring networks, because all the networks are not expected to support the same radio connectivity and thus cannot discover each other directly over the radio interface. The CDIS may have other functions like storing more information of each CM, statistics of the spectrum use, or providing common Quiet Period for spectrum sensing. The CDIS may also use the information of primary users due to an optional interface to TVWS database. The CDIS 107 may reside in a TVBD device, or in the network.

The interface circuits in FIG. 1B may interface with one or more radio transceivers, battery and other power sources, key pad, touch screen, display, microphone, speakers, ear pieces, camera or other imaging devices, etc. The RAM and ROM may be removable memory devices such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. of the control node or coexistence enabler and coexistence manager from a computer program product or article of manufacture in the form of computer-usable media such as resident memory devices, smart cards or other removable memory devices, or in the form of program logic transmitted over any transmitting medium which transmits such a program. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor.

FIG. 1C is an example functional block diagram according to an embodiment of the present invention, illustrating the IEEE 802.11 WLAN AP & TVWS device STA1 that includes both the network controller or coexistence manager 102 and the control node or coexistence enabler 100. Master device 101 is registered through the control node or coexistence enabler 100 to the network controller or coexistence manager 102. The coexistence manager 102 communicates with the primary database 104 and the coexistence network element Coexistence Discovery & Info Server (CDIS) 107 via the Internet interface 156. The coexistence manager 102 accesses the primary database 104 to obtain available secondary channels in the TV band white space. The coexistence manager 102 accesses the coexistence network element Coexistence Discovery & Info Server (CDIS) 107 to obtain Potential neighbor networks' addresses. The coexistence manager 102 sends resource reallocation messages to the coexistence enabler 100. The example coexistence manager 102 includes a processor 154 that includes a dual core central processing unit CPU_1 and CPU_2, a RAM memory, a ROM memory, and an interface for input/output devices. The database interface 156 provides the interface to the primary database 104 and the coexistence network element Coexistence Discovery & Info Server (CDIS) 107. The CDIS 107 may reside in the STA1 device, or in the network.

The interface circuits in FIG. 1C may interface with one or more radio transceivers, battery and other power sources, key pad, touch screen, display, microphone, speakers, ear pieces, camera or other imaging devices, etc. The RAM and ROM may be removable memory devices such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of an example embodiment of the invention. The program logic may be delivered to the writeable RAM, PROMS, flash memory devices, etc. of the coexistence enabler from a computer program product or article of manufacture in the form of computer-usable media such as resident memory devices, smart cards or other removable memory devices, or in the form of program logic transmitted over any transmitting medium which transmits such a program. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor.

In an example embodiment of the invention, in a first process the Coexistence Enabler (CE) 100 calculates the CoexistenceValue (CV) from some parameters of the network under it, for example the IEEE 802.11 WLAN NETWORK “B”. The CE 100 will transmit a CV value to its CM 102, which will further share it with other CMs of all neighboring networks. In an example embodiment of the invention, in a second process, the CE 100 will transmit its network capabilities to its CM 102, which will share them with the same other CMs of all neighboring networks. In an example embodiment of the invention, in a third process, the spectrum map creation process is performed by the CM 102 from the information received from the CE 100, the primary database 104 and information from the CMs of neighboring networks. The information of these three processes is used when the CE 100 identifies an excess resource need in its network and sends a resource request (RR) containing the amount of additional resources it needs to its CM 102. Each CM 102 has received the CV, the spectrum map and the network capabilities of its own network under CE 100 and neighboring networks. The CM 102 processes the RR, and if an allocation analysis is needed, it uses the CVs of the requesting network and its neighboring networks to evaluate whether the requesting network needing more resources is eligible to for the amount of resources requested in the RR. If the network is eligible to the requested additional resources, its CM 102 will then communicate a new resources allocation to the other CMs of its neighboring networks, or else the CM 102 will inform CE 100 that the network requesting the additional resources is not eligible for the requested resources.

In an example embodiment of the invention, certain parameters provide a good and/or practical representation of the eligibility level to the spectrum resources. The CoexistenceValue (CV) has to be counted with similar methods for each network. Some candidate parameters for the CoexistenceValue include: the number of nodes per network (with particular counting method), the current allocation usage level, and the network capabilities. A particular parameter priority may be used for “tuning the eligibility” among the networks under one CM.

FIG. 1D is an example network diagram according to another embodiment of the present invention, illustrating the IEEE 802.11 WLAN AP and TVWS device STA5, which includes the control node or coexistence enabler 100″, communicating over a backhaul wireline and/or internet link 5 with the network controller or coexistence manager 102″. Master device 101″ is registered through the control node or coexistence enabler 100″ to the network controller or coexistence manager 102″.

FIG. 1E is an example frequency band diagram illustrating an example TDMA coexistence frame 22 in sub-band 12 in the FCC dedicated TV band white space of 470-806 MHz, an example TDMA coexistence frame 24 in sub-band 14 in the FCC dedicated TV band white space of 54-88 MHz, and an example TDMA coexistence frame 26 in sub-band 16 in the earth station-to-satellite locally unused white space band 2.025 GHz to 2.110 GHz, according to an embodiment of the present invention. License-exempt access to these bands as a secondary use for coexistence of networks requesting additional resources, may include restrictions on geographic location, transmission power, range, and bandwidth of the transmissions of the requesting networks.

For example, the 802.11 WLAN standards specify an OFDM-based physical layer with a bandwidth of 20 MHz channel separation. At 11 MHz from the center of the channel, the energy is approximately 20 dB lower than the maximum signal level. Further away from the centre frequency, the energy levels fall further resulting in minimal interference on adjacent channels. The TV band white spaces at 54-88 MHz and at 470-806 MHz are good candidates for coexistence of an 802.11 WLAN wireless LAN channel. The earth station-to-satellite white space band at 2.025 GHz to 2.110 GHz is a good candidate for coexistence of an 802.11 WLAN wireless LAN channel. A TV band white space locally unused by licensed TV broadcasters, for example, in the 174-204 MHz band, representing the local absence of broadcast TV channels 7, 8, 9, 10, and 11, as is the circumstance in the Richmond, Va. (USA) area, is a good candidate for coexistence of an 802.11 WLAN wireless LAN channel.

FIG. 1E shows an example of the location of the white spaces in the RF spectrum and example TDMA coexistence frames in the white space bands, showing the freely available time slots before any networks have been allocated slots. The white spaces include the FCC dedicated TV white space 54-88 MHz band, the FCC dedicated TV white space 470-806 MHz band, and locally unused the earth station-to-satellite white space band 2.025 GHz to 2.110 GHz.

There are a number of TVWS coexistence techniques possible for enabling two or more independently operated wireless networks or devices using different radio technologies adapted for TV white space frequency bands, to access the same TV white space frequency band in the same location without mutual interference. Some examples of coexistence techniques include dynamic frequency selection, transmit power control, listen-before-talk behavior, time division multiplexing different IEEE 802 technologies, message-based on-demand spectrum contention, and control through a centralized network controller or coexistence manager.

The example coexistence technique illustrated here for each sub-band 12, 14, and 16, is time division multiplexing of the slots in TDMA coexistence frames allocated to different IEEE 802 technologies. The two IEEE 802 technologies chosen for this example are the IEEE 802.16h WMAN standard and the IEEE 802.11 WLAN standard. The IEEE 802.16h WMAN uses a fixed outdoor base station, such as the WMAN base station 8, serving indoor and outdoor portable clients, such as the WMAN STA 6. The IEEE 802.11 WLAN station, such as the WLAN access point STA1, may include Internet access and geo-location capability. The TDMA coexistence frame may be divided into a IEEE 802.11 master slot network allocation group and an IEEE 802.16h master slot network allocation group. The IEEE 802.11 master slot network allocation group carries twelve free IEEE 802.11 WLAN white space slots. The IEEE 802.16h master slot network allocation group carries the twelve free IEEE 802.16h WMAN white space slots.

FIG. 1F is an example frequency band diagram illustrating an example TDMA coexistence frame 28 in sub-band 18 in the TV band white space locally unused by licensed TV broadcasters in the 174-204 MHz band, representing broadcast TV channels 7, 8, 9, 10, and 11 in the Richmond, Va. (USA) area, an example TDMA coexistence frame 22 in sub-band 12 in the FCC dedicated TV band white space of 470-806 MHz, and an example TDMA coexistence frame 26 in sub-band 16 in the earth station-to-satellite locally unused white space band 2.025 GHz to 2.110 GHz, according to an embodiment of the present invention.

FIG. 1G is an example map of the Richmond, Va. (USA) geographic area and an overlay of coverage areas for broadcast TV channels 7, 8, 9, 10, and 11, illustrating that there is a locally available TV band white space that is unused by licensed TV broadcasters in the 174-204 MHz band, as shown in FIG. 1F. The cities where there are TV broadcasters for TV channels 7, 8, 9, 10, and 11 in a circular area of approximately 160 kilometers in diameter surrounding the city of Richmond, Va., are shown in the following table. The map of FIG. 1G shows that there is no coverage by licensed TV broadcasters in the 174-204 MHz band, which is therefore a locally available TV band white space.

| | | |
|---|---|---|
| WASHINGTON, DC | TV CHANNEL 7 | 174-180 MHz |
| NORFOLK, VIRGINIA | TV CHANNEL 7 | 174-180 MHz |
| HARRISONBURG, VA | TV CHANNEL 8 | 180-186 MHz |
| WASHINGTON, DC | TV CHANNEL 9 | 186-192 MHz |
| NORFOLK, VIRGINIA | TV CHANNEL 9 | 186-192 MHz |
| WINCHESTER, VA | TV CHANNEL 10 | 192-198 MHz |
| RALEIGH, NC | TV CHANNEL 11 | 198-204 MHz |
| STAUNTON, VIRGINIA | TV CHANNEL 11 | 198-204 MHz |

FIG. 1H is an example of the basic functionalities of the network controller or coexistence manager and the control node or coexistence enabler according to an embodiment of the present invention.

For the control node or coexistence enabler (CE):

CV process: Determine a parameter that characterizes the network's eligibility level to the spectrum resources. The parameter is determined from certain parameters of the network. The parameter may be called a coexistence value (CV). Provide the CV of the network to the CM serving the CE.

RR process: Form a resource request (RR) and issue it to the serving CM. Formed based upon information gathered from the network on its resource needs.

Management process: Registers the CE to a CM in order to become served by the CM. Maintains connection to the CM and provides information e.g. about network capabilities and CE features. Contains support functions that make the actual coexistence management functionality possible.

For the network controller or coexistence manager (CM):

Resource allocation process: Shares CVs from the CEs one is serving with the CMs of the neighboring networks. Exchanges spectrum maps with the CMs of the neighboring networks. Determines resource allocations as described in high level in NC72135 using the CVs and spectrum maps.

Neighbor management: Determines neighbors for the CEs/networks the CM serves (e.g. as per the NC71605) and facilitates connection setup between CMs serving neighboring networks.

CM-to-CM communication: Provides basic communication services for other functions/processes of the CM to exchange information with other CMs. Communication is needed between CMs that serve CEs of neighboring networks to exchange e.g. CV parameter values and RR process related information.

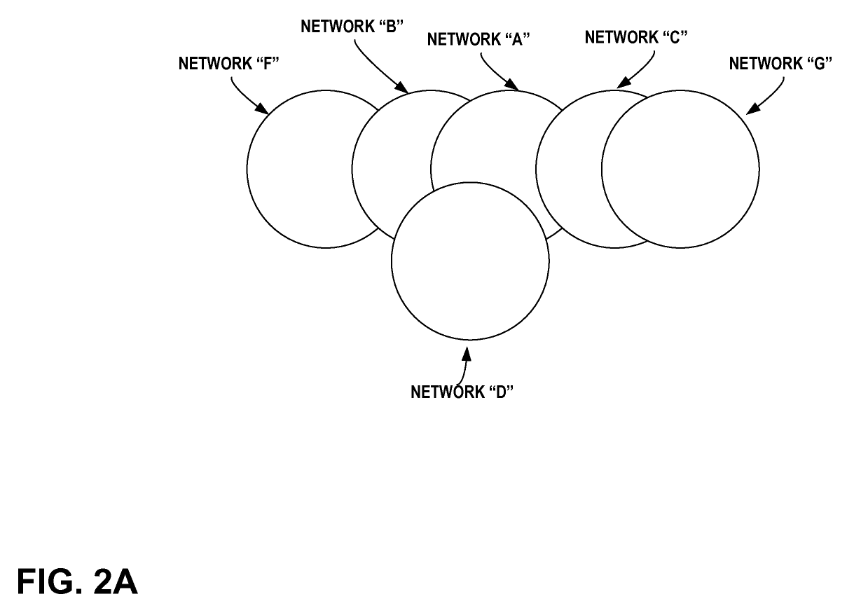

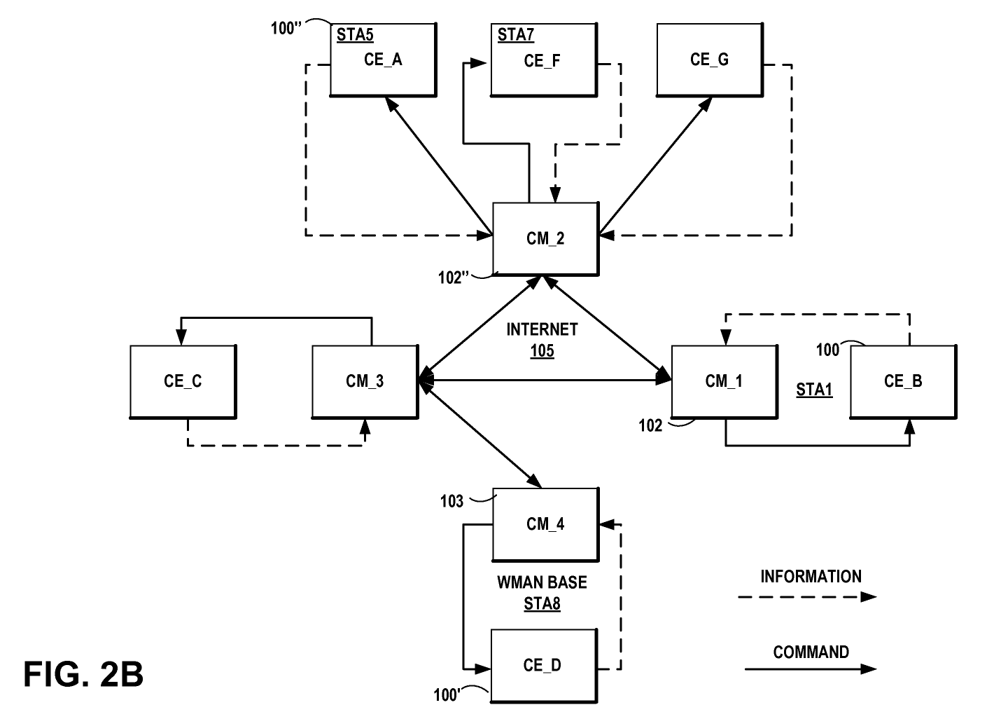

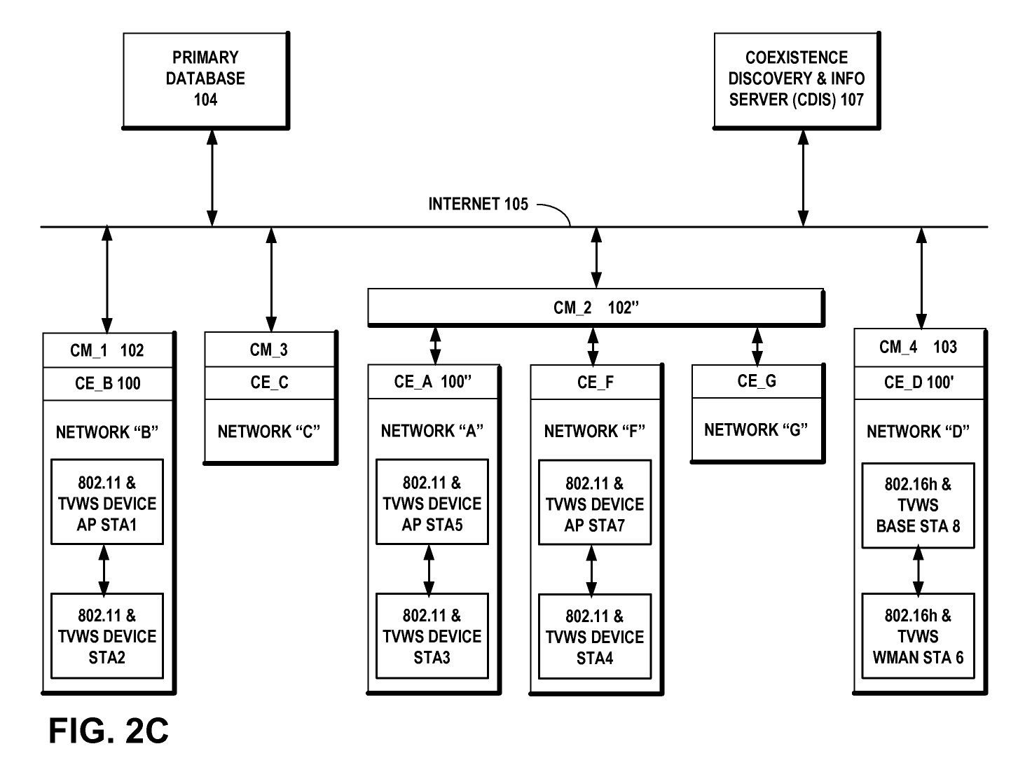

FIG. 2A is an example network topology scenario where the network “B” needs more resources, according to an embodiment of the present invention. An example embodiment of the invention specifies the coexistence entities, their relationships and the resource request method, as illustrated by the following example. The FIG. 2A shows a network scenario, where the circles A, B, C, D, E, F, and G represent the coverage area of each network. These networks are controlled in coexistence by the control node or coexistence enabler and the coexistence manager. Each network has its own coexistence enabler and may have its own coexistence manager or alternately one coexistence manager may control several networks, for example a company WLAN network with several APs.

Procedures to find real neighbors, how to analyze fair resource allocation between the real neighbors, and what content is to be communicated between real neighbors is described in the copending U.S. patent application Ser. No. 12/689,663. filed Jan. 19, 2010, entitled “Apparatus Identification In Coexistence Networking”, by Mika Kasslin, Jari Junell, Juha Salokannel, assigned to Nokia Corporation and incorporated herein by reference.

The identification of neighboring networks may be performed by transmitting a request to a server, such as via an Internet connection, to inquire as to whether other networks are located near enough to the requesting network to be in an operational environment. The server may return information to the requesting network via the Internet identifying other proximately-located networks. The requesting network may utilize this information to communicate with the proximate networks.

In at least one example embodiment, the information provided by the server may include Internet addresses corresponding to network devices in potential neighboring wireless networks in the same operational environment as the requesting network. The requesting network may contact at least some of the potential neighboring networks via the Internet in order to request communication configuration and test information. The other potential networks may respond to these requests, and the requesting network may use the communication received configuration and test information to select a group of candidate neighboring networks. Candidate neighboring networks may be selected based on, for example, the distance from the requesting network to a potential neighboring network, transmission properties (for example, transmission power of potential neighboring networks), etc. Information needed for candidate selection may be provided by potential neighboring networks to the requesting network via an Internet connection.

In accordance with at least one example embodiment, the requesting network may then initiate testing the group of candidate neighboring networks. Testing may comprise transmitting one or more wireless signals that should be receivable by the candidate neighboring networks. The candidate neighboring networks that receive the wireless signals may then transmit reports to the requesting network via an Internet connection confirming receipt of a signal. The requesting network may utilize testing results to select real neighbor networks from the group of candidate neighboring networks.

FIG. 2B is an example of coexistence management of the several networks shown in FIG. 2A according to an embodiment of the present invention. Different network controller or coexistence managers 102 are connected together based on actual network overlapping below them. Also networks A, F, and G may form a company network, where each network has its own control node or coexistence enabler 100″, but all are managed by one network controller or coexistence manager 102″. To complete the architecture view all coexistence managers has a connection to primary database 104 and coexistence network element Coexistence Discovery & Info Server (CDIS) 107, as shown in FIG. 2A. It is possible that some networks may rely only on spectrum sensing (a special mode in FCC TV white spaces).

FIG. 2C is an example arrangement of the control node or coexistence enablers 100 for networks A through G, the network controller or coexistence managers 102 and 103 respectively serving the coexistence enablers 100 and 100′, the primary database 104, and the coexistence network element Coexistence Discovery & Info Server (CDIS) 107, according to an embodiment of the present invention. For example, the coexistence manager CM_1 serves a single coexistence enabler CE_B for network “B” that includes STA1. The coexistence manager CM_3 serves a single coexistence enabler CE_C for network “C”. The coexistence manager CM_4 serves a single coexistence enabler CE_D 100′ for the 802.16 network “D” that includes base STA 8. Coexistence manager CM_2 102″ serves three coexistence enablers CE_A, CE_F, and CEG. Coexistence enabler CE_A 100″ serves network “A” that includes STA5 and STA3. Coexistence enabler CE_F serves network “F” that includes STA4. All four coexistence managers CM_1, CM_2, CM_3, and CM_4 may access each other over the Internet 105, based on actual network overlapping of the networks they serve. All of the coexistence managers CM_1, CM_2, CM_3, and CM_4 have a connection to the primary database 104 and coexistence network element Coexistence Discovery & Info Server (CDIS) 107.

Although the description herein is primarily related to TV white space frequency bands, embodiments of the invention are applicable to any type of white space environment having temporary or long term unused frequencies.

The coexistence manager 102 applies rules in making its determination of which of two networks based on different technologies, should be given priority in spectrum reallocation. For example, WLAN devices are typically designed for better resistance to saturation than WMAN devices, since WMAN devices must be more sensitive to attenuated signals received over a greater range than are WLAN devices. Thus, in an example embodiment of the invention, the coexistence manager 102 will generally favor the reallocation of an 802.11 network to the TVWS band, instead of reallocating the 802.16 network, when spectrum reallocation is requested, so as to remove the source of disturbance from the vicinity of 802.16 network.

The coexistence manager (CM) 102 decides, if no free channel or enough advertized resources were available, whether to grant the request by determining whether resource allocation requires an extensive reallocation or a light reallocation of a number of secondary channels or networks. In a light resource request process, for example, a change in the number of terminals within a single frequency channel may require changes only among the allocations between the users of that channel. In an extensive resource request process, for example, if a primary user reserves a channel, then all secondary users of that channel need to be reallocated to other channels, and a more complete resource reallocation may be initiated.

The coexistence manager 102 then sends to the coexistence enabler 100 in device STA1 the resource reallocation, including Operational parameters, Quiet period parameters, Spectrum sensing strategy, and Time base sync. The coexistence enabler 100 in device STA1 then controls the TV white space MAC to communicate in channels in the TV white spaces band reallocated by the coexistence manager 102, without interference from other networks sharing the same white space channels.

An example embodiment of the types of information exchanged between the coexistence manager 102, primary database 104, Coexistence Discovery & Info Server (CDIS) 107, and control node or coexistence enabler 100 may be as follows.

Between coexistence manager and Primary database:
→Location of coexistence enabler or the associated TVBD to Primary database
←Available channels for secondary usage to coexistence manager

Between coexistence manager and Coexistence Discovery & Info Server (CDIS):
→Location of networks to CDIS
←Potential neighbor coexistence managers to coexistence manager

Processing in coexistence manager:
⇄Spectrum maps
⇄Operational parameters of its own (alternative 1), operational parameters of its own and real neighbors (alternative 2)
⇄time base sync

Between coexistence manager and coexistence enabler:
→Operational parameters to coexistence enabler
→Quiet period parameters to coexistence enabler
→Spectrum sensing strategy to coexistence enabler
→Time base sync to coexistence enabler
←Coexistence value (CV) to coexistence manager
←Spectrum sensing results to coexistence manager
←Network parameters to coexistence manager
←Resource Request to coexistence manager

Procedures to find real neighbors, how to analyze fair resource allocation between the real neighbors, and what content is to be communicated between real neighbors is described in the copending U.S. patent application Ser. No. 12/689,663. filed Jan. 19, 2010, entitled “Apparatus Identification In Coexistence Networking”, by Mika Kasslin, Jari Junell, Juha Salokannel, assigned to Nokia Corporation and incorporated herein by reference.

In an embodiment of the invention, a CM manages “radio environment” of a master TVBD device (TVBD_Own) that the CM serves through a CE. Master TVBD devices in the surroundings are noted as TVBD_Other.

In an embodiment of the invention, the CM categorizes master TVBD devices that surround the TVBD_Own into four categories:

[1] Neighbors: All the TVBD_Other devices that can interfere the TVBD_Own and that can be interfered with by the TVBD_Own (i.e. mutual interference needed). Noted with TVBD_Nbr. The spec has a set of rules and protocols related to neighbors.

[2] One-sided interferers: Two types of TVBD_Other devices that are not neighbors: ones that can interfere with the TVBD_Own (a source interferer device noted with TVBD_I_Src), others that can be interfered with by the TVBD_Own (a destination device noted with TVBD_I_Dst). The spec has a set of rules and protocols related to one-sided interferers.

[3] Follow-up TVBDs: TVBD_Other devices that are “almost” either neighbors or one-sided interferers. These have potential to become neighbors or one-sided interferers (noted with TVBD_Follow_up). A TVBD_Other device is categorized as a TVBD_Follow_up if:
[a] The TVBD_Other was a TVBD_Nbr, TVBD_I_Src or TVBD_I_Dst less than TS_1 ago. TS_1 is a time period that determines how long a CM keeps a bit closer look on the TVBD_Other devices that were neighbors or one-sided interferers some time ago.
[b] The TVBD_Other haven't met the neighbor or one-sided interferer requirements but after some small changes, e.g. transmit power or location, it would be categorized as either a neighbor or one-sided interferer.

[4] Excluded Candidates: TVBD_Other devices that were in the list from the CDIS but are not neighbors, one-sided interferers or follow up TVBDs. Noted with TVBD_Exc-Cand. These may not have any specific role in the CM's neighborhood management functionality.

The CM maintains following kinds of radio environment information base for each TVBD_Own:
TVBD_Own info: Device ID, Spectrum map, Operational parameters, Service registration status, Capabilities, Characteristics (e.g. Coexistence Value), Satisfaction level, etc.
List of TVBD_Nbr
List of TVBD_I_Src
List of TVBD_I_Dst
List of TVBD_Follow_up

For each member of each list following information is maintained:
Info: Information about the TVBD_Other, e.g. device ID, network type, operating parameters;
Obligations: What are obligations of the CM related to the TVBD_Other of this category? What is expected from the CM with respect to the TVBD_Other devices in this category?
Expectations: What are expectations of the CM related to the TVBD_Other of this category? What the CM expects to get/receive.

The following are examples of the information for each category:

Neighbors

[1] Information base per TVBD_Own for each TVBD_Nbr:
[a] Information
   Device ID, Serving CM, Spectrum map, Operational parameters, Service registration status, Capabilities, Characteristics (e.g. Coexistence Value (CV)), Satisfaction level
[b] Obligations
   Keep the TVBD_Nbr's CM updated on the spectrum map and the CV of the TVBD_Own;
   If one serves the TVBD_Nbr and the TVBD_Nbr is registered to Information services, keep the TVBD_Nbr updated on the spectrum map of the TVBD_Own;
   If the TVBD_Nbr registered to Management services, when the CM receives a resource request from the TVBD_Own or a primary appears, determine also the TVBD_Nbr's operational parameters and provide them to the TVBD_Nbr;
   If the TVBD_Nbr registered to Information services, when the CM receives a resource request from the TVBD_Own or a primary appears, determine the TVBD_Nbr's channel utilization proposal and provide that to the TVBD_Nbr.
[c] Expectations
   Updates received on the TVBD_Nbr's spectrum map and CV;
   Updates received on the TVBD_Own's operational parameters if both the TVBD_Own and the TVBD_Nbr registered to the Management services.

One-Sided Interferers

[1] Information base per TVBD_Own for each TVBD_I_Src
[a] Information
   Device ID, Serving CM, Operational parameters;
[b] Obligations
   None
[c] Expectations
   Updates on operational parameters in form of interferer reports

[2] Information base per TVBD_Own for each TVBD_I_Dst
[a] Information
   Device ID, Serving CM
[b] Obligations
   Send updates on operational parameters in form of interferer reports
[c] Expectations
   None

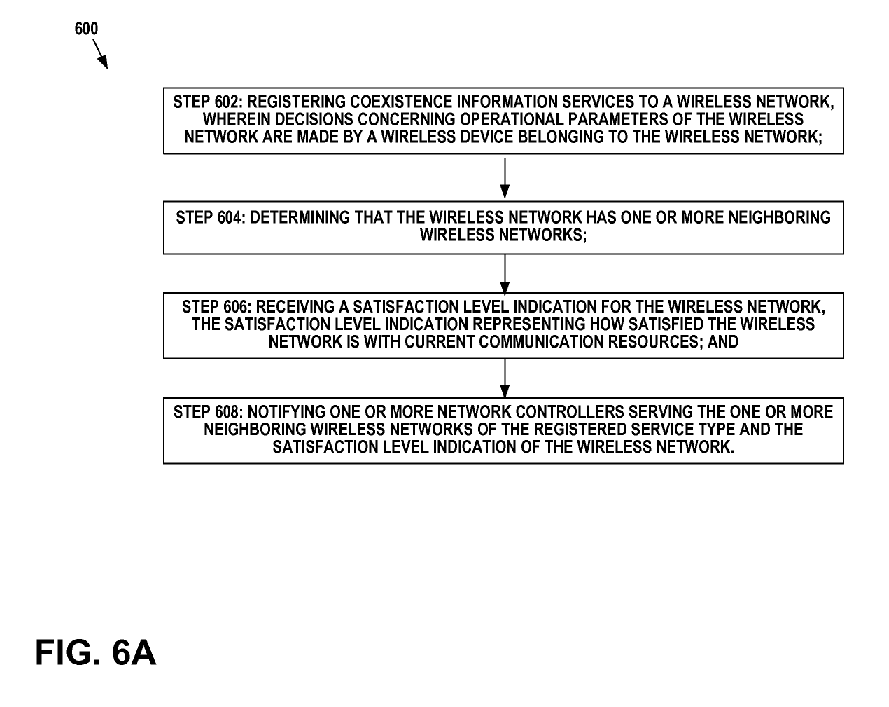

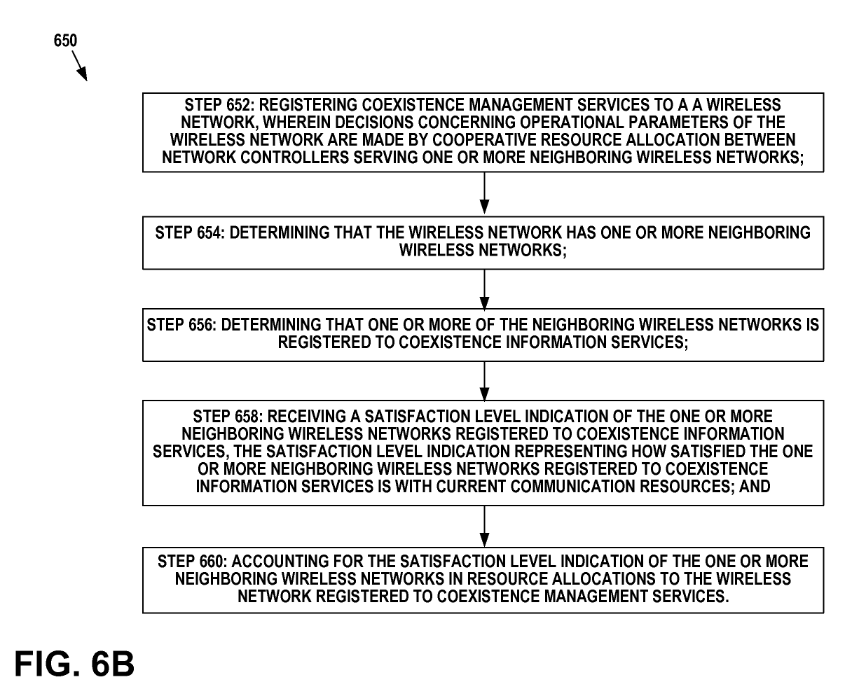

FIG. 6A is an example flow diagram 600 of operational steps of an example embodiment of the method carried out by a coexistence manager (CM) of FIG. 1A registering coexistence information services, according to an embodiment of the present invention. The steps of the flow diagram represent computer code instructions stored in the RAM and/or ROM memory of the coexistence manager (CM), which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 602: registering coexistence information services to a wireless network, wherein decisions concerning operational parameters of the wireless network are made by a wireless device belonging to the wireless network;

Step 604: determining that the wireless network has one or more neighboring wireless networks;

Step 606: receiving a satisfaction level indication for the wireless network, the satisfaction level indication representing how satisfied the wireless network is with current communication resources; and

Step 608: notifying one or more network controllers serving the one or more neighboring wireless networks of the registered service type and the satisfaction level indication of the wireless network.

FIG. 6B is an example flow diagram 650 of operational steps of an example embodiment of the method carried out by a coexistence manager (CM) of FIG. 1A registering coexistence management services, according to an embodiment of the present invention. The steps of the flow diagram represent computer code instructions stored in the RAM and/or ROM memory of the coexistence manager (CM), which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 652: registering coexistence management services to a wireless network, wherein decisions concerning operational parameters of the wireless network are made by cooperative resource allocation between network controllers serving one or more neighboring wireless networks;

Step 654: determining that the wireless network has one or more neighboring wireless networks;

Step 656: determining that one or more of the neighboring wireless networks is registered to coexistence information services;

Step 658: receiving a satisfaction level indication of the one or more neighboring wireless networks registered to coexistence information services, the satisfaction level indication representing how satisfied the one or more neighboring wireless networks registered to coexistence information services is with current communication resources; and

Step 660: accounting for the satisfaction level indication of the one or more neighboring wireless networks in resource allocations to the wireless network registered to coexistence management services.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
registering coexistence information services to a wireless network, wherein decisions concerning operational parameters of the wireless network are made by a wireless device belonging to the wireless network;
determining that the wireless network has one or more neighboring wireless networks;
receiving a satisfaction level indication for the wireless network, the satisfaction level indication representing how satisfied the wireless network is with current communication resources; and
notifying one or more network controllers serving the one or more neighboring wireless networks of the registered service type and the satisfaction level indication of the wireless network.

2. The method of claim 1, further comprising:
receiving one or more reports from the one or more network controllers, including an indication of a type of coexistence system service of the one or more neighboring wireless networks as being the coexistence information services or a coexistence management service wherein one or more network controllers make decisions concerning operational parameters of the wireless network;
receiving a request from the control node associated with the wireless network, inquiring what portion of neighboring networks use a type of coexistence system service; and
providing information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

3. A method, comprising:
registering coexistence management services to a wireless network, wherein decisions concerning operational parameters of the wireless network are made by cooperative resource allocation between network controllers serving one or more neighboring wireless networks;
determining that the wireless network has one or more neighboring wireless networks;
determining that one or more of the neighboring wireless networks is registered to coexistence information services;
receiving a satisfaction level indication of the one or more neighboring wireless networks registered to coexistence information services, the satisfaction level indication representing how satisfied the one or more neighboring wireless networks registered to coexistence information services is with current communication resources; and
accounting for the satisfaction level indication of the one or more neighboring wireless networks in resource allocations to the wireless network registered to coexistence management services.

4. The method of claim 3, further comprising:
receiving one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service; and
reducing a probability of including a neighboring wireless network in reallocation of resources if the satisfaction level indication of the neighboring wireless network indicates that the neighboring wireless network is satisfied and the service type is the coexistence information services.

5. The method of claim 3, further comprising:
receiving one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service;
receiving a request from the control node associated with the wireless network, inquiring what portion of neighboring networks use a type of coexistence system service; and
providing information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

6. An apparatus, comprising:
at least one processor;
at least one memory including computer program code;
the at least one memory and the computer program code configured to, with the at least one processor, cause the coexistence manager at least to:
register coexistence information services to a wireless network, wherein decisions concerning operational parameters of the wireless network are made by a wireless device belonging to the wireless network;
determine that the wireless network has one or more neighboring wireless networks;
receive a satisfaction level indication for the wireless network, the satisfaction level indication representing how satisfied the wireless network is with current communication resources; and
notify one or more network controllers serving the one or more neighboring wireless networks of the registered service type and the satisfaction level indication of the wireless network.

7. The apparatus of claim 6, further comprising:
the at least one memory and the computer program code configured to, with the at least one processor, cause the coexistence manager at least to:
receive one or more reports from the one or more network controllers, including an indication of a type of coexistence system service of the one or more neighboring wireless networks as being the coexistence information services or a coexistence management service wherein one or more network controllers make decisions concerning operational parameters of the wireless network;
receive a request from the control node associated with the wireless network, inquiring what portion of neighboring networks use a type of coexistence system service; and
provide information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

8. An apparatus, comprising:
at least one processor;
at least one memory including computer program code;
the at least one memory and the computer program code configured to, with the at least one processor, cause the coexistence manager at least to:
register coexistence management services to a wireless network, wherein decisions concerning operational parameters of the wireless network are made by cooperative resource allocation between network controllers serving one or more neighboring wireless networks;
determine that the wireless network has one or more neighboring wireless networks;
determine that one or more of the neighboring wireless networks is registered to coexistence information services;
receive a satisfaction level indication of the one or more neighboring wireless networks registered to coexistence information services, the satisfaction level indication representing how satisfied the one or more neighboring wireless networks registered to coexistence information services is with current communication resources; and
account for the satisfaction level indication of the one or more neighboring wireless networks in resource allocations to the wireless network registered to coexistence management services.

9. The apparatus of claim 8, further comprising:
the at least one memory and the computer program code configured to, with the at least one processor, cause the coexistence manager at least to:
receive one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service; and
reduce a probability of including a neighboring wireless network in reallocation of resources if the satisfaction level indication of the neighboring wireless network indicates that the neighboring wireless network is satisfied and the service type is the coexistence information services.

10. The apparatus of claim 8, further comprising:
the at least one memory and the computer program code configured to, with the at least one processor, cause the coexistence manager at least to:
receive one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service;
receive a request from the control node associated with the wireless network, inquiring what portion of neighboring networks use a type of coexistence system service; and
provide information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

11. A computer program product comprising computer executable program code recorded on a computer readable storage medium, the computer executable program code comprising:
code for registering coexistence information services to a wireless network, wherein decisions concerning operational parameters of the wireless network are made by a wireless device belonging to the wireless network;
code for determining that the wireless network has one or more neighboring wireless networks;
code for receiving a satisfaction level indication for the wireless network, the satisfaction level indication representing how satisfied the wireless network is with current communication resources; and
code for notifying one or more network controllers serving the one or more neighboring wireless networks of the registered service type and the satisfaction level indication of the wireless network.

12. The computer program product of claim 11, further comprising:
code for receiving one or more reports from the one or more network controllers, including an indication of a type of coexistence system service of the one or more neighboring wireless networks as being the coexistence information services or a coexistence management service wherein one or more network controllers make decisions concerning operational parameters of the wireless network;
code for receiving a request from the control node associated with the wireless network, inquiring what portion of neighboring networks use a type of coexistence system service; and
code for providing information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

13. A computer program product comprising computer executable program code recorded on a computer readable storage medium, the computer executable program code comprising:
code for registering coexistence management services to a wireless network, wherein decisions concerning operational parameters of the wireless network are made by cooperative resource allocation between network controllers serving one or more neighboring wireless networks;
code for determining that the wireless network has one or more neighboring wireless networks;
code for determining that one or more of the neighboring wireless networks is registered to coexistence information services;
code for receiving a satisfaction level indication of the one or more neighboring wireless networks registered to coexistence information services, the satisfaction level indication representing how satisfied the one or more neighboring wireless networks registered to coexistence information services is with current communication resources; and
code for accounting for the satisfaction level indication of the one or more neighboring wireless networks in resource allocations to the wireless network registered to coexistence management services.

14. The computer program product of claim 13, further comprising:
code for receiving one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service; and
code for reducing a probability of including a neighboring wireless network in reallocation of resources if the satisfaction level indication of the neighboring wireless network indicates that the neighboring wireless network is satisfied and the service type is the coexistence information services.

15. The computer program product of claim 13, further comprising:
code for receiving one or more reports from one or more network controllers serving the one or more neighboring wireless networks, including an indication of a type of coexistence system service of the one or more neighboring wireless networks as being coexistence information services wherein decisions concerning operational parameters of the wireless network are to be made by a wireless device that is part of the wireless network or the coexistence management service;
code for receiving a request from the control node associated with the wireless network, inquiring what portion of neighboring networks use a type of coexistence system service; and
code for providing information to the control node associated with the wireless network concerning the types of coexistence system service reported by the one or more network controllers serving one or more neighboring wireless networks, to enable selection of a type of coexistence system service for the wireless network, based on the types of coexistence system service reported by the one or more network controllers serving one or more neighboring wireless networks.

16. The method of claim 1, further comprising:
receiving operational parameters of the wireless network comprising bandwidth, utilization, maximum operation power, and antenna configuration; and
notifying one or more network controllers serving the one or more neighboring wireless networks of the operational parameters of the wireless network.

17. The apparatus of claim 6, further comprising:
the at least one memory and the computer program code configured to, with the at least one processor, cause the coexistence manager at least to:
receive operational parameters of the wireless network comprising bandwidth, utilization, maximum operation power, and antenna configuration; and
notify one or more network controllers serving the one or more neighboring wireless networks of the operational parameters of the wireless network.

18. The computer program product of claim 11, further comprising:
code for receiving operational parameters of the wireless network comprising bandwidth, utilization, maximum operation power, and antenna configuration; and
code for notifying one or more network controllers serving the one or more neighboring wireless networks of the operational parameters of the wireless network.

19. The method of claim 1, further comprising:
receiving one or more reports from the one or more network controllers, including an indication of a type of coexistence system service of the one or more neighboring wireless networks as being the coexistence information services or a coexistence management service wherein one or more network controllers make decisions concerning operational parameters of the wireless network;
receiving a request from the control node associated with the wireless network, inquiring about service use of the one or more neighboring wireless networks, including requesting a list of the one or more neighboring wireless networks and for each of the one or more neighboring wireless networks, an indication as to whether the neighboring wireless network is registered to the coexistence management service or to the coexistence information service; and
providing information to the control node associated with the wireless network concerning the one or more neighboring wireless networks, including a list of the one or more neighboring wireless networks and for each of the one or more neighboring wireless networks, an indication as to whether the neighboring wireless network is registered to the coexistence management service or to the coexistence information service.

20. The apparatus of claim 6, further comprising:
the at least one memory and the computer program code configured to, with the at least one processor, cause the coexistence manager at least to:
receive one or more reports from the one or more network controllers, including an indication of a type of coexistence system service of the one or more neighboring wireless networks as being the coexistence information services or a coexistence management service wherein one or more network controllers make decisions concerning operational parameters of the wireless network;
receive a request from the control node associated with the wireless network, inquiring about service use of the one or more neighboring wireless networks, including requesting a list of the one or more neighboring wireless networks and for each of the one or more neighboring wireless networks, an indication as to whether the neighboring wireless network is registered to the coexistence management service or to the coexistence information service; and
provide information to the control node associated with the wireless network concerning the one or more neighboring wireless networks, including a list of the one or more neighboring wireless networks and for each of the one or more neighboring wireless networks, an indication as to whether the neighboring wireless network is registered to the coexistence management service or to the coexistence information service.

21. The computer program product of claim 11, further comprising:
code for receiving one or more reports from the one or more network controllers, including an indication of a type of coexistence system service of the one or more neighboring wireless networks as being the coexistence information services or a coexistence management service wherein one or more network controllers make decisions concerning operational parameters of the wireless network;
code for receiving a request from the control node associated with the wireless network, inquiring about service use of the one or more neighboring wireless networks, including requesting a list of the one or more neighboring wireless networks and for each of the one or more neighboring wireless networks, an indication as to whether the neighboring wireless network is registered to the coexistence management service or to the coexistence information service; and
code for providing information to the control node associated with the wireless network concerning the one or more neighboring wireless networks, including a list of the one or more neighboring wireless networks and for each of the one or more neighboring wireless networks, an indication as to whether the neighboring wireless network is registered to the coexistence management service or to the coexistence information service.
